(19) United States
(12) Patent Application Publication
(10) Pub. No.: US 2006/0006108 A1
(43) Pub. Date: Jan. 12, 2006

(54) Fuel cell cartridge and fuel delivery system

(76) Inventors: Jeffrey Lynn Arias, Downey, CA (US); Huyen Ngoc Dinh, Oceanside, CA (US); Carl Allan Kukkonen, Dana Point, CA (US); Gerhard Beckmann, Altamont, NY (US); Carl Allan Kukkonen III, San Diego, CA (US)

Correspondence Address: FISH & RICHARDSON, PC, P.O. BOX 1022, MINNEAPOLIS, MN, 55440-1022, US

(21) Appl. No.: 11/177,234

(22) Filed: Jul. 7, 2005

Related U.S. Application Data
(60) Provisional application No. 60/585,831, filed on Jul. 8, 2004.

(51) Int. Cl. H01M 8/00; B01D 35/30

(52) U.S. Cl. 210/232; 429/12

(57) ABSTRACT

The subject matter described herein relates to a fuel cell cartridge for providing fuel to a fuel cell. Also described are fuel delivery systems, fuel cells, and related techniques.

### CLAIM OF PRIORITY

This application claims priority from U.S. Pat. No. 60/585,831 entitled “Fuel Delivery System for Fuel Cells”, filed Jul. 8, 2004, the contents of which are hereby fully incorporated by reference.

### BACKGROUND

The subject matter described herein relates, in part, to a fuel delivery system for a fuel cell. The subject matter described herein also relates to a fuel cell with an improved fuel delivery system. The subject matter described herein also relates a fuel cartridge that may be coupled to a fuel delivery system and/or a fuel cell.

Fuel cells are electrochemical devices that directly convert chemical energy of reactants (i.e., fuel and oxidant), into electricity. For an increasing number of applications, fuel cells are more efficient than conventional power generation, such as combustion of fossil fuel and more convenient than portable power storage, such as lithium-ion batteries. Several different materials may be used in fuel cells though methanol and hydrogen are being increasingly adopted due to their high specific energy.

Fuel cells operate by electrochemically converting fuel and oxidants to generate electric power and reaction products. Such devices generally comprise an electrolyte disposed between two electrodes. Electrochemical reactions are induced on the electrodes by employing an electrocatalyst. Solid polymer fuel cells employ a membrane electrode assembly comprising a solid polymer electrolyte or a proton exchange membrane (PEM) provided between the electrode layers.

Several reactants are known for use in PEM fuel cells delivered by both liquid or gaseous streams. The oxidant stream for example may be pure oxygen gas or air. The fuel stream may be generally pure hydrogen gas, hydride, an acid, or a liquid organic fuel mixture. A direct methanol fuel cell (DMFC) is a type of direct liquid feed fuel cell in which the liquid methanol used as fuel is directly oxidized at the anode. The hydrogen ions generated at the anode pass through the membrane and combine with oxygen and electrons on the cathode side to produce water. Electrons are unable to pass through the membrane and therefore, flow from the anode to the cathode through an external circuit driving an electric load that consumes power generated by the cell.

In a DMFC, the fuel is methanol or a mixture of water and methanol. Methanol or methanol mixtures are delivered as a liquid to an anode chamber in a DMFC, where methanol is oxidized as part of the electrochemical conversion of fuel to electricity. The half cell reactions of a direct methanol fuel cell are given by:
Anode: CH3OH+H2O→CO2+6 e−+6H+
Cathode: 6e−+6H++ 3/2 O2>3H2O
Overall: CH3OH+ 3/2 O2→CO2+2H2O

Fuel cells incorporated into power sources for portable devices promise longer runtimes than conventional battery systems because they utilize high-energy content fuels. Several fuel cell technologies are currently under development for commercialization in portable power applications, such as methanol, formic acid, sodium borohydride, fuel cells and hydrogen polymer electrolyte membrane fuel cells. However, to facilitate widespread adoption of fuel cells in portable power applications, improvements in fuel cell cartridges as well as fuel cell delivery systems are required.

### SUMMARY

In one aspect, a fuel cartridge for use in a fuel cell comprises a fuel reservoir locatable within a fuel container to dispense fuel through a coupling device into the fuel cell. The reservoir may comprise a housing with an anterior wall and a posterior wall, an external surface and an internal surface, fuel outlet provided in the anterior wall and connectable to the fuel cell through the coupling device. In some variations, the fuel reservoir dispenses fuel through a fuel feed loop of the fuel cell.

The fuel cartridge may be single walled or it may be multi-walled such that it houses fuel in segregated chambers. The reservoir may hold a wide variety of volumes of fuel depending on the desired application, including, but not limited to a range of 1 ml to 10 liters of fuel, and in some variations, a range of 20 to 500 ml.

The fuel may be a liquid fuel, a gaseous fuel, an aerosolized fuel, a solid fuel, or a combination thereof. For example, the fuel may be a hydrocarbon fuel selected from a group comprising: methanol, ethanol, dimethyl ether (DME), dimethoxymethane (DMM), trimethoxymethane (TMM), trioxane, formic acid, formaldehyde, butane, propane, methane, propylene, ethylene, propanol, glycol, mixtures thereof with water, mixtures thereof with acids and mixtures thereof with base.

The reservoir may take a wide variety of shapes, including, for example, rectangular, prismatic, box-shaped, cylindrical, and/or tubular. In some variations, the reservoir may be manufactured from a material selected from a group comprising extruded aluminum, plastics, composites and any material that is substantially inert to reaction with the housed fuel. The reservoir may include flexible or deformable portions and/or rigid portions. The reservoir, in some configurations, may be of a corrugated material on at least a portion thereof to provide a compressible/expandable bellows to evacuate fuel therefrom.

The reservoir may comprise a contiguous surface to house a fuel with a fuel outlet provided on an anterior wall thereof. In addition or in the alternative, the reservoir may comprise a flexible volume defining chamber provided within a rigid housing and/or a valve at the fuel outlet to seal the reservoir when unconnected to a fuel delivery system. Such a valve, may for example, be a one way valve selected from a group comprising: electromechanically actuated valves, ball-check valves, needle valves (e.g., valve having a receiving member to be penetrated by a elongate element), aircraft refueling valves, and mechanically actuated valves.

A fuel cartridge may include a removable barrier to cover the fuel outlet when not in use. Such a removable barrier may have a tab portion and either slide across the face of the fuel outlet similar to a seal protecting a standard laser printer cartridge, or it may be completely removable (such as a metallic food receptacle cover). In some variations, the reservoir comprises a security element to prevent tampering with fuel contained therein.

The reservoir may include a locking portion at the fuel outlet to secure the cartridge to a coupling device. Such a locking portion may be selected from a group comprising a mechanical locking device, a friction locking device and a mechanical restraint device. A mechanical locking device may be selected from a group comprising: a bayonet attachment, a quick release lock, screw thread, a detent lock, and a spring-loaded lock. A friction locking device may be an O-ring. A mechanical restraint device may be a male or a female locking device that mates with a corresponding female or male component on a coupling device.

In some variations, a fuel cartridge may also be provided with a coupling sensor to detect coupling therebetween and a coupling device. For example, the coupling sensor may be selected from a group comprising a micro-switch residing on the housing of the cartridge and actuated on mating of the cartridge and coupling device, a magnetic switch actuated on mating of the cartridge and coupling device, a pair of electrical contacts in contact with a metal portion of the fuel cartridge, and a light detection sensor selected in turn from an optical sensor.

The fuel cartridge may also comprise at least one positive pressure inducing element to dispense fuel therefrom selected from a group consisting an internal-pressure-providing element inside the cartridge, a mechanical force inducing element, and a combination thereof. The internal-pressure-providing element may comprise a high vapor pressure hydrocarbon which is added to the fuel. If the utilized fuel is methanol, the high vapor pressure hydrocarbon may be selected from a group comprising butane, dimethyl ether and propane. The mechanical force providing element may be selected from a group comprising a piston operable using at least one actuation element selected from a group comprising: spring, a screw, a motor, pneumatic pressure and hydraulic pressure; a portion of the reservoir housing, and an elastomer foam.

The fuel within the fuel cartridge may be evacuated from the cartridge by gravity, diffusion, or through capillary action. Such capillary force may be provided by a foam within the cartridge with a constant porosity or a foam with a porosity gradient enabling transfer of fuel by increase of capillary force near the fuel outlet. Alternatively or in addition, the capillary force may be provided by a wicking element (e.g., felts, fibers, fabrics and foams) with a constant porosity or a with a porosity gradient to increase the capillary force near the opening. In yet another variation, the capillary force may be provided by one or more visco-elastic fluids provided within the fuel cartridge and selectively screenable (e.g., removed, filtered or separatable) at the fuel outlet of the cartridge to prevent introduction thereof into the coupling device. In still another variation, the capillary force may be provided by one or more capillary tubes located within the container and/or internal pressure.

The fuel may be removed or evacuated by a gas provided within the cartridges a gas vent element being incorporated on the cartridge. The cartridge may comprise one or more gas storage elements to store a propellant segregated from the fuel. Such a gas storage element may comprise a bladder, bag, expandable vessel, rupturable capsule, piston separating gas and fuel and compartment coupled to a pressure responsive valve. The cartridge may also or in the alternative comprise a release mechanism to relieve pressure within the cartridge on reaching a predetermined level. The release mechanism may be a valve that may be opened when a pre-determined pressure level is reached comprising a pressure-sensitive rubber plug mounted within an orifice of the cartridge, a foam or a gelling agent located within the fuel to slow release of fuel out from the cartridge, and/or a pressure-sensitive vent or a selectively permeable membrane.

The fuel cartridge may comprise a metering element to control the rate of fuel discharge therefrom. The metering element may be selected from a group comprising a metering orifice, a porous material, a porous element located at the fuel outlet, a wicking material located at the outlet of the container and a flow restriction valve.

The fuel outlet may be selected from a group comprising one or more tubes connected to the fuel cell, a wicking material located external to the cartridge and operatively associated therewith, two or more concentric or coaxial tubes to enable circulation of a portion or all of the fuel stream through the cartridge, and two or more tubes to allow exit of fuel and entrance of a gas and/or liquid.

In some variations, the fuel cartridge may be configured to coupled to a docking station. In such variations, the fuel cartridge may comprise a securing element to secure the cartridge against a docking station sealing surface. A securing element may be selected from a group comprising: bayonet type lock for a cylindrical cartridge and a molded plastic end cap adhesively attachable for an aerosol can type cartridge. A sample molded plastic end cap may comprise an element to enable grasp and turn to selectively engage or disengage from the docking station sealing surfaces. A sample bayonet lock may comprise a safety element and has a high torque requirement for disengagement. In addition, a the bayonet lock may be a pin and notch type arrangement wherein either the pin or the notch are located on the cartridge external surface and engage with a corresponding notch or pin on the fuel docking station sealing surface.

In another aspect, a fuel cartridge for use in a fuel cell may comprise a fuel reservoir locatable within a fuel container to dispense fuel through a coupling device into a fuel feed loop of a fuel cell with the reservoir comprising a housing with an anterior wall and a posterior wall, an external surface and an internal surface, fuel outlet provided in the anterior wall and connectable to the fuel cell through the coupling device, and wherein fuel evacuation is enabled by at least one of an element chosen from the group comprising a capillary action element, a mechanical force element, internal gas pressure or a combination thereof.

A capillary action element may comprise at least one of a foam, an aero gel, porous ceramics, porous silicon with decreasing pore size towards the fuel outlet and/or a capillary tube. A foam may have an open ended cell structure of 50% to 99% porosity, and may comprise a material that is hydrophilic and compatible with the fuel. A foam may, for example, be a polyurethane foam with a porosity of 60 to 80 pores per inch. The foam may be wedge shaped and compelled into the cartridge in order to achieve graduated porosity with smaller pores near the fuel outlet. Pellets with pores smaller than the pores of the foam may be inserted into the pores of the foam through the fuel outlet.

The foam may comprise a plurality of foam blocks of differing porosities. Each foam block nearer the fuel outlet may have a smaller pore size than the previous foam block. A wide range of foam blocks may be arranged in such a configuration, such as, for example, two to one hundred foam blocks. In some variations, the foam blocks comprise foams of different porosities provided in an annular or concentric manner, the smallest-pore foam being in the center and connected to the fuel outlet. In other variations, the foam blocks may comprise a conical-shaped piece of foam inserted into a flexible foam with a larger-pore-size, thereby compressing the foam pores in the flexible foam nearest the outlet. A capillary tube may be inserted into one or more foam blocks of different porosities to enable progressive increase in capillary forces towards the fuel outlet.

In some variations, the capillary action element progressively increases capillary force towards the fuel outlet thereof using an open celled foam filler or wicking material located within the cartridge and provided with smaller pores nearer the fuel outlet of the cartridge in order to impart a greater capillary pull of fuel towards fuel outlet.

The fuel cartridge may also comprise a high vapor pressure hydrocarbon (e.g., butane) to provide positive pressure to evacuate the fuel from the fuel outlet. A foam material may be used in combination with the high vapor pressure hydrocarbon in order to achieve progressively high capillary forces towards the fuel outlet.

In another aspect, a fuel cartridge for use in a fuel cell may comprise a fuel reservoir locatable within a fuel container to dispense fuel through a coupling device into a fuel cell. The reservoir may comprise a housing with an anterior wall and a posterior wall, an external surface and an internal surface, fuel outlet provided in the anterior wall and connectable to the fuel feed loop through the coupling device. The housing may have an opening towards one end and an end piece towards an end opposite the opening, the opening being provided with an interlocking element to secure the cartridge to a coupling device, the end piece being securable to the housing with a fuel compatible adhesive material or being integral therewith.

In yet another aspect, a fuel cartridge may comprise a fuel reservoir locatable within a fuel container to dispense fuel through a coupling device into a fuel feed loop of a fuel cell. The reservoir may comprise a housing with an anterior wall and a posterior wall, an external surface and an internal surface, fuel outlet provided in the anterior wall and connectable to the fuel feed loop through the coupling device, and discrete containers to house fuel and a propellant.

Such a reservoir may comprise an aluminum container incorporating a bladder to separate a pressurized gas and the fuel. In other variations, the reservoir may comprise a piston disposed to separate a pressurized gas and the fuel. A motion detecting element may be used to calculate movement of the piston in order to determine, for example, an amount of fuel remaining in the reservoir. The motion detecting element may detect movement magnetically, by capacitance, inductively, or acoustically, or the like. A fuel may be methanol and a pressurized gas may be carbon dioxide or an inert gas.

In a further aspect, a fuel cartridge may comprise a fuel reservoir locatable within a fuel container to dispense fuel through a coupling device into a fuel feed loop of a fuel cell, wherein the reservoir comprises a housing with an anterior wall and a posterior wall, an external surface and an internal surface, fuel outlet provided in the anterior wall and connectable to the fuel feed loop through the coupling device, and wherein the cartridge comprises one or more reinforcement elements to resist bulging thereof. The reinforcement elements may cooperate with corresponding one or more reinforcement elements provided on a cartridge docking slot and/or may comprise one or more ribs provided on the internal surface of the cartridge.

In still another aspect, a fuel cartridge for use with a fuel cell may comprise a fuel reservoir locatable within a fuel container to dispense fuel through a coupling device into a fuel feed loop of a fuel cell, wherein the reservoir comprises a housing with an anterior wall and a posterior wall, an external surface and an internal surface, fuel outlet provided in the anterior wall and connectable to the fuel feed loop through the coupling device, and wherein the cartridge is provided with one or more mechanical members requiring mating with one or more corresponding locks located in a cartridge docking station.

A mechanical member may comprise one or more grooves provided on an exterior surface of the cartridge and cooperatable with one or more notches provided on the interior surface of the cartridge docking slot and/or one or more ridges provided on an exterior surface of the cartridge and cooperatable with one or more grooves provided on the interior surface of the cartridge docking slot and/or one or more grooves and one or more ridges provided on an exterior surface of the cartridge and cooperatable with one or more ridges and one or more grooves provided on the interior surface of the cartridge docking slot. The mechanical member may comprise notches, pins, ridges, holes, or other protuberances so as to enable it to fit within, and engage corresponding orifices in the cartridge docking station.

In another aspect, a fuel cartridge may comprise a fuel reservoir locatable within a fuel container to dispense fuel through a coupling device into a fuel feed loop of a fuel cell, wherein the reservoir comprises a housing with an anterior wall and a posterior wall, an external surface and an internal surface, fuel outlet provided in the anterior wall and connectable to the fuel feed loop through the coupling device, and wherein the cartridge is actuatable through an opening in the wall by one or more pressure inducing elements to evacuate fuel therefrom.

The fuel may be contained in bellows or a bladder and the cartridge housing being provided with one or more plates or pistons in contact with the bladder or bellows and actuatable by an actuation element in order to depress the bellows or bladder and thereby evacuate fuel through the fuel outlet of the cartridge. The actuation element may comprise one or more external springs operatively associated with the one or more plates or pistons through the one or more slots provided on the cartridge housing. Leaf springs, coil springs, wire springs, and/or any other energy storage configuration may be used.

The actuation element may comprise a combination of a spring and a plunger element, the plunger element being in operational contact with the plate or piston to depress the bellows or bladder and thereby evacuate fuel through the fuel outlet, and/or a threaded activating rod drivable by a rotating motor and screw, thereby pushing on one or more plates or pistons within the cartridge and thereby depressing the bellows thereby resulting in external mechanical pressurization.

The pressure inducing element may comprise a fuel-filled bladder in the cartridge, a small external orifice provided on the cartridge and a seal therefore to press against a sealing surface of a fuel cell to provide pressurized air. A seal may be an O-ring.

The pump may be driven by an external power supply element. The pump may be a piston or diaphragm type pump. The pressure inducing element may comprise one or more hydrocarbons located within the fuel to pressurize the cartridge. Such a hydrocarbon may be used as a mixture within the fuel, and the cartridge may further comprise a separation element being provided to separate the fuel and the hydrocarbon within the cartridge. Additional hydrocarbon may be stored external to a bladder containing the fuel and/or within a balloon located within the bladder containing the fuel and is used to pressurize the bladder.

In another aspect, a fuel cartridge for with a fuel cell may comprise a fuel reservoir locatable within a fuel container to dispense fuel through a coupling device into the fuel cell, wherein the reservoir comprises a housing with an anterior wall and a posterior wall, an external surface and an internal surface, a fuel outlet provided in the anterior wall and connectable to the fuel cell through the coupling device, a fluid inlet connectable to a fluid pressurizing element.

In some variations, the cartridge may further comprise a bladder enveloping fuel and wherein a pressurizing fluid is introduced between the bladder and the internal surface of the fuel reservoir through the fluid inlet. The fluid inlet may be sealed by a plug within one of the anterior and posterior walls of the reservoir. In another variation, the cartridge may comprise a plug within the posterior wall of the reservoir and a piston disposed between the plug and the fuel outlet. If a piston is utilized, the cartridge may further comprise or be coupled to a position sensor for monitoring movement of the piston. A processor may be coupled to the position sensor for estimating an amount of fuel within the processor based on a position of the piston. In addition, in some variations, water is circulated through the reservoir via the fluid inlet and the fuel outlet.

In another aspect, a fuel cartridge may comprise a housing configured to couple to a fuel cell, an orifice in the housing, an inlet in the housing for receiving fuel from a fuel source, and an outlet segregated from the inlet in the orifice for delivering fuel to a fuel cell.

In a further aspect, an apparatus may comprise a housing forming a fuel reservoir, and a spring activated valve that releases fuel within the fuel reservoir in a first position and maintains fuel within the fuel reservoir in a second position, wherein the spring activated valve includes a biasing element for maintaining the valve in the second position and a receiving portion for engaging an external member to oppose the biasing element and cause the valve to shift to the first position when the fuel container is coupled to a fuel cell.

In still a further aspect, a fuel delivery system for a fuel cell may comprise a fuel container, a coupling device, a feed subsystem, a fuel treatment subsystem, and a control subsystem. The feed subsystem may be coupled to the coupling device and delivers and controls the fuel flow from the coupling device to the fuel treatment subsystem. The feed subsystem may be controlled by the control subsystem through a solenoid valve connected through the control system and a pump. Such a pump may be selected from a group comprising peristaltic pumps, piston based pumps, piezo-electric pumps and rotary pumps.

The feed subsystem may comprise a fuel concentration sensor to determine the concentration of the fuel being delivered to the fuel treatment subsystem. The concentration sensor may be connected to the feed subsystem internally, externally, or a combination of internally and externally. A coupling element may be connected in a feed line between the container and the feed subsystem to determine the presence of the container coupled to the coupling device. The coupling detection element may be from a group comprising an electrical switch comprising a micro switch, magnetic switch, proximity sensor, optical devices or pressure sensors.

The feed subsystem may comprise a check valve, a siphon or a pump in order to recover water from an air system fluidly coupled thereto. The feed subsystem may be coupled to a fuel treatment system in order to pre-treat fuel within an anode fuel stream prior to exposure thereof to an anode. The fuel pretreatment subsystem may comprise an element selected from a sump and a selectively permeable membrane to remove carbon dioxide from the fuel cell. The treatment subsystem may comprise a heating element to maintain fuel at a predetermined temperature. Such a heating element may be selected from a group comprising: heat exchanger, evaporator, a transpiration cooling element, electric resistance heater, ceramic heater, a catalytic heating element, a heat transfer portion of the fuel cell, and any combination thereof.

The fuel treatment system may comprise a filter to remove impurities in fuel. The filter may be a permeable membrane or barrier. In some variations, a vaporization element is provided to vaporize the fuel and/or a reforming element is provided to dissociate hydrogen from the fuel. The control system may be electrically connected, RF connected, or IR connected to the coupling device, container, feed subsystem, fuel treatment subsystem in order to monitor signals received therefrom indicative of operation thereof and thereafter transmit correctional or modification signals to adjust performance thereof. Furthermore, the control system may be connected to an external user interface for transmitting information regarding the performance of the fuel delivery system to a user.

A power element may be provided to power the control system and selected from a fuel cell, a solar cell, an external battery and a combination thereof. In some variations, the control system may comprise a feedback element to provide feedback of operation of fuel delivery system thereto. The coupling device may comprise an accumulator comprising of a piston and spring provided within a housing. The spring may be adjusted at a bias in order to maintain a constant steady pressure on an exiting fuel stream.

The coupling device may be provided with a 3-way solenoid valve coupled to the accumulator and a control system and configured to permit flow of fuel in a unidirectional manner from the coupling device and into the accumulator. The 3-way solenoid valve may be operatively connected to the control system for control thereof.

In another aspect, a fuel delivery system for a fuel cell comprising a fuel container for delivering fuel to a fuel loop and first, second, and third pistons. The first piston is operable to drive at least one other piston when a liquid is introduced therein. The second piston is operable to pump fuel and water solution around the fuel loop when the first piston is filling and when it is emptying. The third piston is operable to pump water from a water recovery system into the fuel loop.

The fuel delivery system may also comprise a sump configured to collect and store water recovered from exhaust gas condensate. In other variations, a cartridge docking station may be included into which the fuel container may be inserted. A spring or other biasing element, such as a leaf or wire type spring deflectable, or relocatable to admit and secure the fuel container may be included. The spring may be made from hardened metal, carbon fiber, plastic or ceramic. Alternatively, the cartridge docking station may comprise a biased plunging element provided on the exterior surface thereof to secure the fuel container. In yet another alternative, the cartridge docking station may comprise a threaded activating rod drivable by a rotating motor and screw to secure the fuel container.

The cartridge docking station may comprise at least one reinforcing element to prevent bulging of a fuel container on insertion therein. The reinforcing element may comprise parallel ribs over the exterior surface of the cartridge docking station. In addition, the ribs may be provided in an interior of the fuel container and perpendicular to the ribs on the docking station. In some variations, the cartridge docking station may comprise smooth walls and taper for removal of the fuel container.

The fuel container may take on a wide variety of configurations including a fuel-filled bladder, with a small external hole in case and a seal in order to provide external mechanical pressurization therein. Such a seal may be an O-ring provided on the fuel container and in contact with a sealing surface of a fuel cell and an interlock to forward a signal for operation of a pressurizing pump.

The fuel container may comprises one or more coupling elements to couple with a cartridge docking station. The coupling elements may comprise one or more ridges, grooves, notches, pins, depressions, patterns, provided on a fuel cartridge and corresponding receiving portions provided on the cartridge docking station. Complimentary features may be found on the cartridge docking station.

The fuel delivery system may also comprise a fuel treatment subsystem having one or more valves or pumps to transfer fuel to a fuel cells stack. It may also or alternatively comprise a concentration sensor is provided therein to monitor electrical properties, concentration level and performance of fuel. In some variations, the fuel delivery system may comprise a feed subsystem that mixes fuel into an anode feed-stream which delivers the fuel to an anode side of a fuel cell and/or the fuel may be introduced into the fuel loop at high velocity to promote turbulence in order to mix by diffusion. Fuel may be delivered to the fuel loop by gravity, diffusion, capillary action or external pressure.

A sensing element may be provided to detect the level of fuel within the fuel container and the rate of flow of fuel. Optionally, an evacuation element may be connected to the fuel container. The evacuation element may, for example, comprise a piston exerting mechanical force, which includes a portion of fuel cell housing and a biased spring or an elastomeric foam.

The fuel delivery system may comprise a coupling device that transfers fuel from the fuel container to a fuel cell and securely couples to the fuel container to prevent the escape of fuel or fuel vapor into an adjacent environment. Relatedly, the fuel container may be configured to house a propellant gas within the container such that the propellant does not mix or diffuse with the fuel and does not pass into the fuel cell while the fuel is being delivered to the coupling device.

In another aspect, a method of maintaining a positive pressure inside a fuel cell cartridge may comprise adding a high-vapor-pressure hydrocarbon in a fuel cell cartridge. In some variations, the method may further comprise mixing the high vapor pressure hydrocarbon with the fuel and a separating element to separate gas from liquid in a fuel container or before fuel reaches a fuel cell stack. The method may comprise pressurizing a fuel containing bladder stored inside the fuel container by the high vapor pressure hydrocarbon. In yet another variation, the method may comprise storing the high vapor pressure hydrocarbon high vapor pressure hydrocarbon external to a bladder contain in the fuel container containing fuel.

The subject matter described herein provides many advantages. For example, it provides an improved fuel delivery system for use in fuel cells which enables enhancement and control of the rate of fuel delivery into the fuel cell. Additionally, the current subject matter provides a method for maintaining a positive pressure inside a fuel cartridge without any external pressure sources. Moreover, the current subject matter enables a fuel cell to overcome problems associated with elevated temperatures due to the internal vapor pressure of the hydrocarbon fuel.

The subject matter described herein also provides a solution to a problem with conventional fuel cartridges, where counterfeiting is rampant. In yet a further advantage, fuel cartridges are provided that increased fuel reservoir volumes while minimizing the size and cost of the fuel cartridges.

### DESCRIPTION OF DRAWINGS

FIG. 1 is a schematic diagram of a first variation of a fuel delivery system.

FIGS. 2A and 2B illustrate various types of fuel cartridge configurations.

FIG. 3 is a schematic diagram illustrating variations of a fuel cartridge introducing fuel into a fuel feed or fuel circuit/fuel-cell-loop.

FIG. 4 is a schematic diagram of a second variation of a fuel delivery system.

FIG. 5 is a schematic diagram of a coupling device used in conjunction with a cylindrical fuel container.

FIG. 6 is a schematic representation of a cylindrical fuel container with a molded plastic end cap.

FIG. 7 is a schematic representation of a third variation of a fuel delivery system.

FIG. 8 is a schematic representation of a fourth variation of a fuel delivery system.

FIG. 9 is a schematic of a fuel container comprising a foam having a graduated porosity.

FIG. 10 is a schematic diagram of a cartridge reinforced with structural ribs.

FIG. 11A is a schematic representation of a first variation of a fuel container and a fuel container docking station.

FIG. 11B is a schematic representation of a second variation of a fuel container and a fuel container docking station.

FIG. 12A is a schematic representation of a first variation of a fuel container.

FIG. 12B to FIG. 12E illustrate further variations of fuel containers and fuel container docking stations.

FIG. 13 is a schematic representation of a variation of a fuel container with a sealing surface.

FIG. 14A to FIG. 14F illustrate variations in which progressively higher capillary forces are provided toward an opening orifice in a fuel container.

FIG. 15A to FIG. 15C illustrate variations in which additional hydrocarbon in a fuel increases a pressure within a fuel cartridge.

FIG. 16A is a schematic diagram of a fuel delivery system utilizing a metering pump.

FIG. 16B is a schematic diagram of a diaphragm pump.

FIG. 16C is a schematic diagram of a pump utilizing a bladder.

FIG. 17 is a schematic diagram of a coupling device for receiving a fuel cartridge.

FIG. 18A is a schematic diagram of a first variation of a container having a bladder operable to pressurize fuel within the container.

FIG. 18B is a schematic diagram of a first variation of a container having a propellant fluid operable to pressurize fuel within the container.

FIG. 18C is a schematic diagram of a first variation of a container having a piston operable to pressurize fuel within the container.

FIG. 19A is a schematic diagram of a second variation of a container having a bladder operable to pressurize fuel within the container.

FIG. 19B is a schematic diagram of a second variation of a container having a propellant fluid operable to pressurize fuel within the container.

FIG. 19C is a schematic diagram of a second variation of a container having a piston operable to pressurize fuel within the container.

FIG. 20 is a schematic diagram of a container having a valve to selectively provide fuel.

### DETAILED DESCRIPTION

The subject matter described herein will now be described in detail with reference to the accompanying illustrative drawings. While, the following passages relate mainly to direct methanol feed fuel cells, it will be appreciated by the skilled artisan that the subject matter described herein may also be used with other liquid, solid, vapor or aerosol feed fuel cell arrangements as well as with other fuels including ethanol, formaldehyde, formic acid, borohyrdrides, and other hydrocarbon fuels.

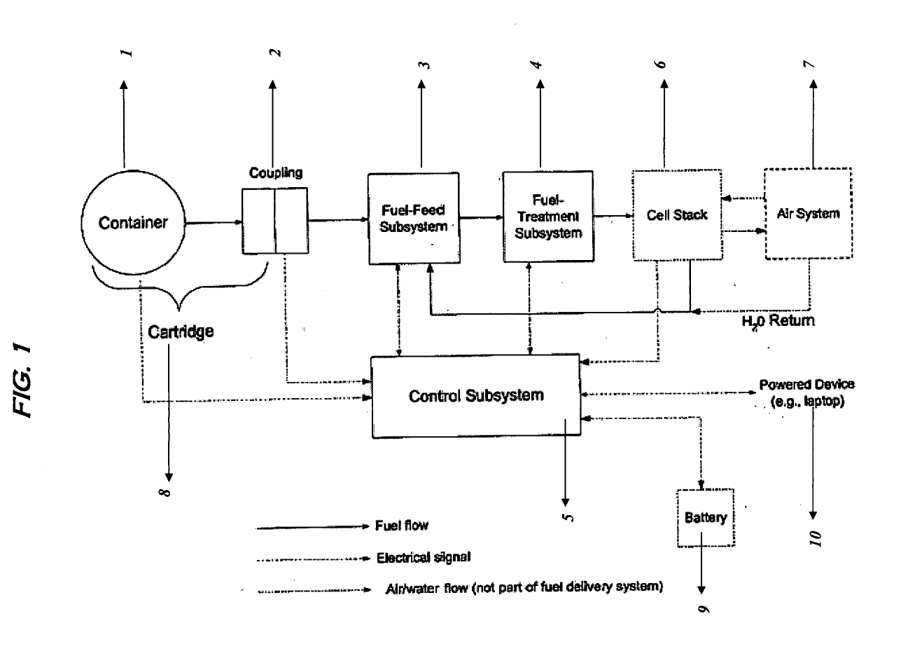

With reference to FIG. 1, a fuel container 1 may be connected to a coupling device 2 which in turn may be connected to a fuel feed sub-system 3. The fuel feed sub-system may be connected to a fuel cell stack 6 through a fuel treatment sub-system 4. The fuel flow path may follow the above route in the fuel delivery. All the above elements may be connected to a control sub-system 5 that monitors and controls the functioning of the fuel delivery system. The control sub-system may also be connected to the fuel cell stack 6, to an air delivery system 7, to a power supply element such as a battery or capacitor 9 and to one or more devices 10, if any, to be powered by a fuel cell.

In FIG. 1, the fuel container 1 may be configured to house fuel required for operation of the fuel cell. In a illustrative feature, the container 1 may store from 1 ml to 10 liters of fuel and in some variations, between 20-500 ml. The fuel may be liquid, gas, solid, or a combination thereof. The fuel may comprise a hydrocarbon fuel such as methanol, ethanol, dimethyl ether (DME), dimethoxymethane (DMM), trimethoxymethane (TMM), trioxane, formic acid, formaldehyde, butane, propane, methane, butane, propylene, ethylene, propanol, alcohols, and glycol or mixture with water and/or acids and bases, which are suitable for powering a fuel cell. The fuel may also be ammonia or any other hydrogen carrier. Alternatively, the fuel may substantially comprise a chemical hydride such as sodium borohydride, or it may be a combination of a chemical hydride and a hydrocarbon fuel.

The fuel container 1 may be a single wall fuel container or a multiple wall fuel container, which may house more than one fuel segregated in different fuel compartments. For example, if the fuel container 1 is used in connection with a methanol fuel cell, one compartment may house methanol and the other compartment may house water.

The fuel cell container 1 may be rectangular, prismatic, box-shaped, tubular or any other shape provided that it is capable of being connected to the coupling device 2. Preferably, the container 1 is manufactured from a lightweight, low-cost material with sufficient structural integrity to house the fuel. Exemplary materials include, metals such as extruded aluminum, plastics, composites and other materials that are substantially inert to reactions with the housed fuel. One of ordinary skill in the art will appreciate that the container 1 may confine the fuel in a variety of manners, such as with a contiguous surface (sealed container), a bladder within a non-sealed container, or a fixed and moving contiguous surface (piston in a tube). The container 1 may be rigid or it may be flexible/deformable. A portion or all of the container 1 may be corrugated to provide a portion of compressible/expandable bellows such that pressure on the container may be used to evacuate the fuel from the container 1, or may have a portion with thin walls (such as a bladder or pouch) that may be compressed to expel fuel. The structural components of the container 1 may be made from a wide variety of materials provided that such materials do not contaminate the fuel or otherwise affect any catalysts or components within the container 1.

The fuel delivery system of the subject matter described herein may include a coupling device 2 in order to couple the container 1 to the fuel cell to permit the transfer of fuel. The coupling device 2 securely couples the fuel cartridge 8 to prevent the escape of the fuel or fuel vapor into the environment adjacent to the fuel cell. This sealing may be achieved by incorporating a valve therein that is sealed when the container 1 is not attached to the fuel cell or using a one way valve to prevent the flow of material out of the coupling device 2. The valves which may be used include “quick-disconnect” valves such as those used for aircraft refueling, mechanically-activated valves, electro-mechanically activated valves, ball valves, or needle valves such as valves used to seal sporting equipment balls. The container 1 may also be provided with a removable adhesive or barrier to cover a fuel outlet provided thereon, when it is shipped or stored, and which may be removed or pierced by a member on the coupling device 2 to allow fuel to flow outwardly. The coupling device 2 may also utilize seals to prevent undesired escape of fuel from the coupling device such as O-rings or elastomeric membranes. The coupling device 2 may be configured to prevent inadvertent or undesired detachment of the cartridge 8 once coupled since such occurrences interrupt the operation of the fuel cell and may result in the release of fuel into the environment surrounding the coupling device 2. Several devices may be used to achieve this result including mechanical locking devices, such as bayonet attachments, quick release locks, screw threads, and detent locks (including spring-loaded locks).

The cartridge 8 may also be secured using a friction device such as an O-ring or a mechanical restraint (a lock behind the cartridge—such as in the housing for a laptop computer). The coupling device 2 may be provided with an element to detect coupling between the cartridge 8 and the coupling device 2. Elements may include a micro-switch that resides on either the container 1 or the coupling device 2, the completion of an electric circuit, or a magnetic switch all of which are activated when the cartridge 8 is advanced into the coupling device 2. In addition, the connection detection mechanism may also be activated by the detection of intensity of a light source within the coupling device 2.

The feed subsystem 3 may be coupled to the coupling device 2 and primarily acts to deliver and control the fuel from the coupling device 2 and the cartridge 8 to the fuel treatment subsystem 4. The feed subsystem 3 may be provided with a fuel concentration sensor to determine the concentration of fuel being delivered to the fuel treatment subsystem 4. In the alternative, the feed subsystem 3 may be in communication with an external fuel concentration sensor. Depending on the fuel utilized by the fuel cell, the sensor may be a methanol sensor such as those described in U.S. Pat. Nos. 6,254,748, 6,303,244, and 6,306,285, all of which are hereby incorporated by reference. The concentration sensor may also measure the electrical properties of the fuel or the performance of the fuel cell to determine concentration (e.g., by measuring voltage, current and temperature) by comparing the measurements with known concentration levels. The concentration sensor may also determine concentration levels using optical sensors (utilizing diffraction, absorption, refractivity and intensity measurements) or by measuring density. The feed subsystem 3 may also mix the fuel into an anode feed-stream, which delivers fuel such as a mixture of water and methanol to an anode-side of the fuel cell. The feed subsystem 3 may be circulating, as shown in FIG. 1, or non-circulating where the fuel flows only towards the anode.

The feed subsystem 3 may be configured to remove gas bubbles within the fuel cell. This removal may be accomplished using a sump with a gas-permeable membrane or other valve or membrane that selectively allows carbon dioxide and/or other gases to be purged from the system. The feed subsystem 3 may be configured to detect the level of fuel within the fuel container 1 and/or to determine how much fuel has passed through the feed subsystem 3, and more specifically, to determine when the fuel container 1 is empty. The fuel level may be determined through a variety of mechanisms, including, detecting the presence or absence of gas exiting the container 1, detecting the vapor pressure of the gases within the container 1, by measuring the amount or fuel that passes through the feed system 3 (through a flow meter or other device, monitoring the fuel cell performance, monitoring the weight of the container 1, optically monitoring the transmissive and/or reflective properties of the container 1 and its contents, or by proving a visually transparent or semi-transparent window on the container 1). These variations may be assisted by utilizing a fuel (e.g., colored fuel), liquid (e.g., colored liquid) that is less dense than the fuel, through floating foam or solids. The feed subsystem 3 may similarly detect how much fuel has passed therethrough using a variety of arrangements, by counting pump oscillations or rotations (where the pump pumps out a substantially a standard amount of fuel), by counting revolutions of a flow meter, by measuring capacitance of the fuel stream, through optical detections (especially if the fuel is colored), or magnetically by detecting the position of a magnetized device (such as a piston) within the container 1.

The fuel may be mixed into an anode feed stream that delivers the fuel by the feed subsystem 3. The fuel such as a mixture of water and methanol may be delivered to the anode-side of the fuel cell. The feed subsystem 3 may be a circulating system, or non-circulating such as one where the fuel flows only towards the anode. The mixing of methanol may occur sufficiently after the initial introduction of the fuel into the anode feed stream to allow for optimal mixing. The mixing may be carried out by a mixing device that generates turbulent flow, or otherwise acts to rotate, pulse, vibrate, or aerate the feed stream. The fuel may also be added via a T-junction with the fuel being added at an angle perpendicular to the flow of the dilute fuel. In other variations, gas is introduced into the anode stream to agitate the stream to ensure that the fuel is sufficiently mixed within water. The fuel may be introduced or otherwise injected into the feed stream at high velocity to promote turbulence, and thus, more efficient mixing by only diffusion, thereby raising the power capability of the fuel cell.

In one variation, the feed subsystem 3, rather than the coupling 2, determines the presence of a container 1 coupled to coupling device 2. Similar to the description above with regard to the coupling device 2, the presence of a container 1 may be determined by several different techniques including, an electrical switch (i.e. micro-switch, where the placement of the container 1 within the coupling 2 completes an electrical circuit), an electrical property sensing device for sensing properties such as inductance or capacitance of the container 1, an optical device that measures optical properties such as reflectively, transmissivity, reflectivity, an optical security device, which activates the fuel cell only if it detects a predetermined optical pattern (such as bar code scanner), or a pressure sensor that detects pressure in the feed line from the container 1 such as pressure transducer or a mechanical pressure-activated switch.

In the case of cartridges for use with liquid feed fuel cells, the feed subsystem 3 may recover water from an air system 7 fluidly coupled to the feed subsystem 3 in order to minimize the amount of liquid that needs to be stored within the container 1, and thereby minimizing the size of the container 1. In another variation, the water may be circulated via a check valve between the air system 7 and feed subsystem 3, a siphon, or by a pump. The pump may be a rotary pump, peristaltic pump, piezoelectric pump, or a piston based pump (where the piston motion may be generated using a solenoid), a pump powered by a pressured source (such as the container 1 by using the pressurized fuel or propellant gas to drive a piston or rotary pump or pump the fuel by a jet pump, entrained gas bubbles, or fluidics, thereby eliminating the need for a separate electrical, magnetic, or systolic pump and enables a simpler system), or an external source. The anode feed stream may be circulated within the fuel cell using a pump such as a rotary pump, peristaltic pump, piezoelectric pump, or a piston based pump (where the piston motion may be generated using a solenoid). The pump may also be powered from a pressured source such as the container 1 or by an external source.

A fuel treatment subsystem 4 may be coupled to the feed subsystem 3 in order to subject the fuel to a pretreatment step within an anode fuel stream prior to its exposure to the anode. In another variation, the fuel treatment subsystem 4 may be coupled to the feed subsystem 3 in order to pretreat the fuel within the anode fuel stream prior to its exposure to the anode. The fuel treatment subsystem 4 performs one or more of the following functions: (i) remove carbon dioxide from the anode fuel stream; (ii) heat the anode fuel stream; (iii) remove impurities within the fuel; (iv) aerosolize the fuel (in some variations); (v) vaporize the feed stream; and/or (vi) disassociate hydrogen ions from the fuel stream. Carbon dioxide may be removed using a sump or a selectively permeable membrane. The fuel may be maintained at a predetermined temperature using a variety of heat transfer devices, such as a heat exchanger, an evaporator, transpirational cooling, or as combination of the same.

Heating of the fuel where required may be effected using traditional methods such as an electrical resistance heater, a ceramic heater, (chemically by reaction with a catalyst), or through heat exchange with the hot part of the fuel cell which typically operates at 60° C. and above. Impurities may be removed using filters (such as foam, porous ceramics, fibers and other meshed materials), or through a permeable membrane or a barrier. In those fuel cells that deliver aerosolized fuel to the fuel cell stack, the fuel treatment system includes a aerosolizer (for example see U.S. Pat. No. 6,440,594, the contents of which are hereby incorporated by reference). The fuel treatment subsystem 4 may also vaporize the fuel through heating or flash vaporization (when the pressure within the system is below the vapor pressure of the fuel). The fuel treatment system 4 may also be configured to dissociate hydrogen from the fuel through use of a reformer.

The fuel delivery system may also include a control subsystem 5 for controlling and/or monitoring various parameters of the components within the system. The control subsystem 5, may be electrically coupled to all major components within the fuel delivery system so that the signals indicative of component operation parameters may be received by the control subsystem 5, and the control subsystem 5 may send actuation signals to modify or otherwise adjust the performance of each component. The control subsystem 5 may also be coupled to a user interface for transmitting information regarding the performance of the components within the fuel delivery system to a user. The control subsystem 5 may be powered by the fuel cell, or in the alternative by an external power source such as battery 9, solar cell, capacitor, or a combination thereof. In one variation, the fuel delivery system may provide a signal to the user of a fuel cell indicative of the level of fuel within the fuel cell by receiving a signal from at least one sensor indicative of fuel level and transmitting such information to the interface. The control subsystem 5 may be arranged such that it provides feedback to the components within the fuel delivery system to ensure that operation within pre-determined parameters.

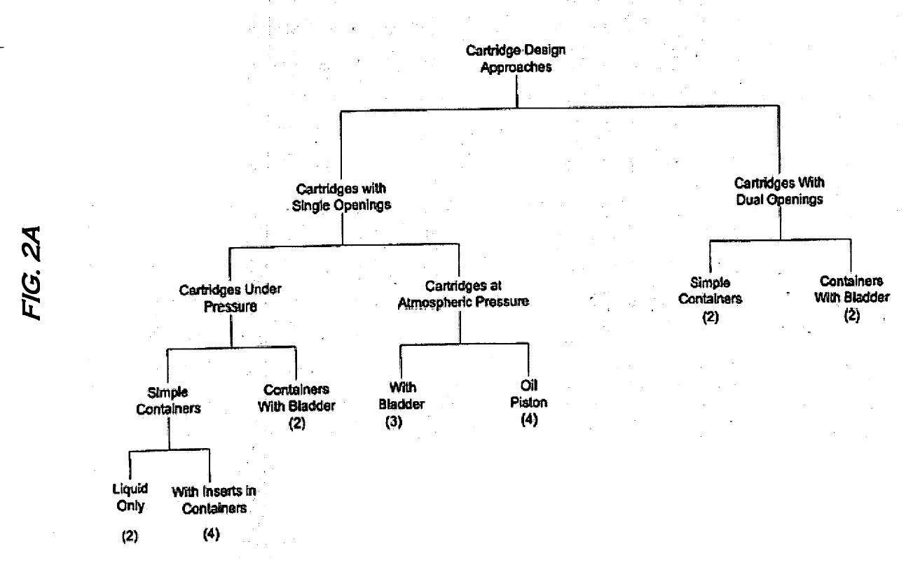

FIG. 2A depicts various types of fuel cartridges which may be used in fuel delivery system of the subject matter described herein. FIG. 2B depicts an illustrative method of fuel transfer from a container 1 to a coupling device 2. During operation, fuel to power a fuel cell may be delivered without interruption. As illustrated in FIG. 2A, fuel may be delivered to the coupling device 2 of the fuel cell. In some variations, the fuel within the container 1 is under pressure such that when the container 1 is opened, the fuel inside will flow towards the container opening. The internal pressure of the container may be a result of (i) compressed gas within the fuel (e.g., CO2) or an inert gas); (ii) using a fuel with a vapor pressure greater than that of atmospheric pressure at room temperature (e.g., butane); (iii) providing a liquid (miscible or non-miscible with the fuel) with a vapor pressure greater than atmosphere at room temperature (e.g., butane), (iv) a pressure responsive valve that opens when the pressure in the container falls below a present value (e.g., 20 psig), where the opening of the valve releases a gas, or causes materials to fracture and react to emit a gas (e.g., CO2), or (v) raising the temperature of the fuel by localized or complete heating of the fuel (where in some variations the heat is generated using an electrical resistance heater (external or internal to the container), a thermal electric cooler/heater, or an inductive heater coil (in the case of a metal container)).

A positive pressure inside the cartridge 8 may be useful in cartridges with foam, and in configurations in which there is no other force available to move the fuel to the cartridge opening, or thence even to the fuel cell stack. One method of maintaining a positive pressure inside the fuel cartridge may be to add an additional high vapor pressure hydrocarbon to the fuel. The vapor pressure of the additional hydrocarbon may be generally sufficiently high to be gaseous at normal ambient temperatures. The additional hydrocarbon material should not be harmful to the fuel-cell components (e.g., catalyst), and optionally the hydrocarbon material may be usable as a fuel. For a direct methanol feed fuel cell, butane may be used. Butane has a boiling point of −0.5° C. at one atmosphere, and a vapor pressure of about 45 psia at room temperature, or 30 psig, which is a useful but not excessive pressure. Other hydrocarbons, which may be suitable for both pressurization and a fuel, include dimethyl ether, or propane.

In one variation, the fuel is evacuated from the container 1 using a mechanical force used in lieu of or in addition to the internal pressure within the container 1. This mechanical force may be provided for example, by a piston provided within the container 1 and configured to reduce the volume within which the fuel is stored. The piston may be movable using traditional techniques including using a spring, a screw, a motor, pneumatics or hydraulics where the piston actuating device may be internal or external to the container 1. If the container 1 is flexible or deformable such as a bladder, bellows, pouch and the like, a mechanical force may be used to compress the container. Examples of mechanical forces may include an external member such as a piston, a portion of the housing in which the fuel cell is stored during operation and it may be compressed by a biased spring or an elastomer such as foam. In addition, the container 1 may be configured so that the fuel stored within cannot be tampered with or opened, by hand or with commonly available devices such as ball-point pen or paperclip.

The fuel is delivered to the coupling device 2 in one variation, by gravity, diffusion, or through capillary action (or with the assistance of capillary action). A capillary force may be provided which moves the liquid to the opening of the container 1, and may be the result of (i) a foam within the container 1 that has a constant porosity, or having a porosity gradient as compared to the fuel to increase the capillary force near the opening; (ii) visco-elastic fluids within the fuel container 1 (which may be selectively screened at the opening to prevent introduction into the coupling device 2); (iii) wicking materials (e.g., felts, fibers, fabrics or foams) or (iv) one or more capillary tubes within the container 1. Evacuation of the fuel from the container 1 may be achieved by a combination of capillary force and internal pressure, as well as external pressure. The combined pressure may be sufficient to expel the liquid out of the capillary materials, and if a gas is utilized, the gas may expel the liquid without first escaping from the container 1. In one variation, a gas vent may be incorporated into the container 1 or at any site in the fuel delivery system to effectuate venting after the fuel has been evacuated from the container 1, or as a pressure safety valve.

The fuel may introduced to the coupling device 2 in a manner that reduces or eliminates the need for pumps or other pressure sources within the fuel delivery system. In the case of liquid methanol feed fuel cells, the fuel may be introduced in a manner to most efficiently mix with water to create a solution that may optimally interact with a fuel cell membrane electrode assembly. The fuel may be injected through one or more orifices or channels to create a turbulent or convective process in a fuel feed stream. Alternatively or in combination, the fuel introduced into the system through the coupling device 2 from the container 1, may be pressurized, or the container 1 may include a propellant gas, such that fuel discharge from the container 1 turns or otherwise powers a pump that circulates the fuel feed stream. Such an arrangement may provide increased power per surface area than a pure diffusion system, and it may eliminate or lessen the need for electrical, magnetic, peristaltic, or systolic pumps, which increase the cost, size and complexity of a fuel delivery system.

In other variations, the container 1 may be configured to house propellant (such as gas) within the container 1 such that the propellant does not mix or diffuse with the fuel and does not pass into the fuel cell while the fuel is being delivered to the coupling device 2. The propellant may be stored by several different mechanisms, including (i) a bag or bladder within the container 1 similar to those used with traditional aerosol delivery devices; (ii) an expandable vessel that stores a compressed materials (e.g., a balloon having compressed gas); (iii) rupturable capsules outside a bag or bladder; (iv) a piston separating gas and liquid; (v) a compartment coupled to a pressure-responsive valve; or (vi) surrounding the fuel (provided that the propellant is non-inert with relation to the fuel).

In some fuel cells, and depending on the fuel delivery method, it may be desirable to restrict the rate of fuel that exits the container 1. Exemplary restricting devices include a metering orifice, porous material within the container, a porous element at the opening of the container, wicking material at the opening, a flow restricting valve, and the like. The flow may also be controlled by restricting the operating parameters of a fuel-transfer pump. Such a restricting device ensures that the fuel does not accidentally escape from the container 1 outside of the coupling device 2 while delivering fuel at a rate required by the fuel cell for consistent operation (i.e., for direct methanol fuel cells, a flow rate of 0.4 ml/hr/watt to 20 ml/hr/watt is sufficient).

In another variation the container 1 may comprise a release mechanism in order to relieve the pressure within the container 1 should such pressure exceed a predetermined level. One such release mechanism may be a valve that opens when a predetermined pressure level is reached, such as a pressure-sensitive rubber plug mounted within an orifice of the container, which is blown-out. Another mechanism may be to include a material such as a foam or a gelling agent, within the fuel that slows the release of the fuel out of the container opening and/or, in the case of liquid fuel, slows the vaporization of the fuel. A pressure-sensitive vent may also be used, as well as a selectively permeable membrane.

In the operation of the fuel delivery system of the subject matter described herein, the fuel may be expelled from the container 1 through (i) one or more tubes connected to the fuel cell; (ii) a wicking material housed within the coupling device (that may communicate with the fuel circuit within the fuel cell); (iii) two tubes that permit the circulation of a portion or all of the fuel stream (such as dilute methanol in water) through the container (this may be two separate tubes, they may be concentric or coaxial); or (iv) two tubes, allowing exit of fuel and entrance of a gas and/or liquid.

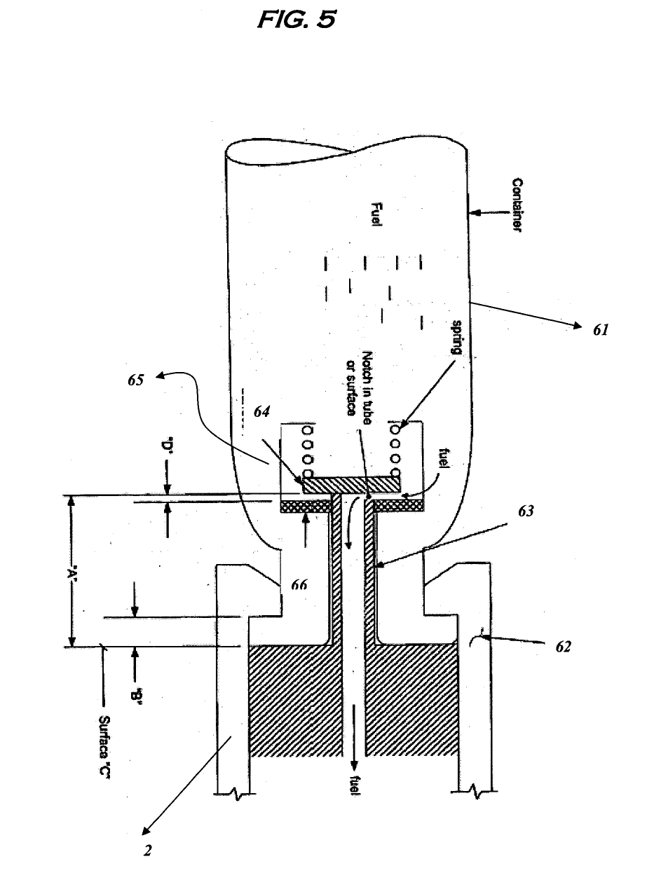

The fuel delivery system may also secure the fuel cartridge firmly against docking-station sealing surfaces. In the case of cylindrical cartridges, a bayonet type of lock, requiring, for example, a quarter-turn to lock may be used. In the case of an aerosol cylinder 71 as depicted in FIG. 6, a molded plastic end cap 72 may be adhesively or mechanically attached, the cap 72 having elements for enabling it to be grasped and turned. The bayonet lock 69 may be such that the torque required for disengagement is sufficiently high so as to impart a child-proof feature. The bayonet lock may be of various types, a pin and notch arrangement being shown, and either the male or female parts may be on the cartridge.

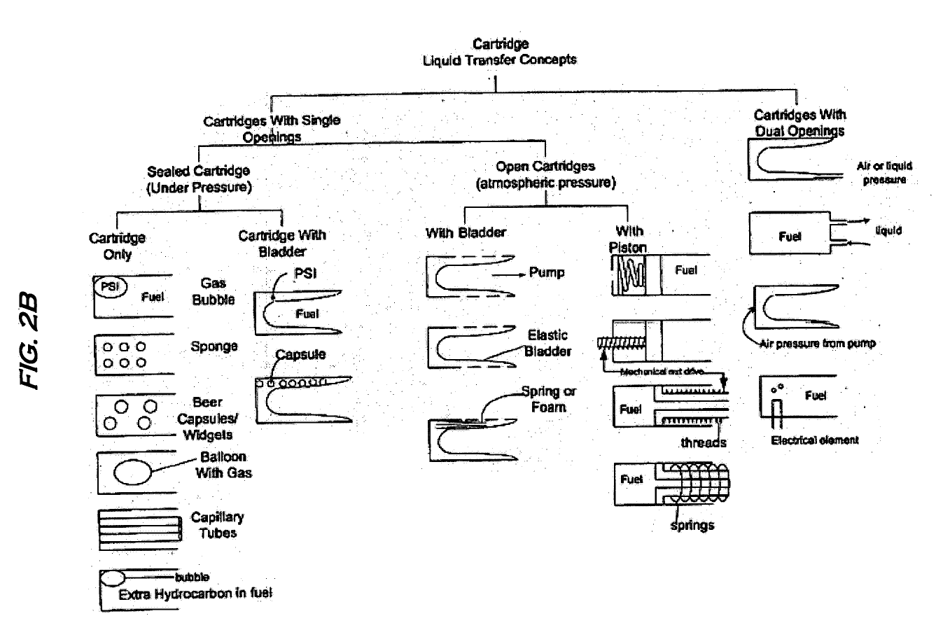

In the method of the subject matter described herein, fluid flow may be activated by a valve such as a solenoid valve 11 (FIG. 3) or other actuation mechanism which is opened by electrical actuation on receiving a signal from the control subsystem 5 or through pumps such as peristaltic pumps, piston-based pumps, piezo-electric pumps or rotary pumps. These valves and pumps, in addition to transferring fuel from the cartridge 8 to the fuel cell stack 6 or fuel treatment subsystems 4, may also be used to prevent the flow of fuel out of the coupling device 2 when the cartridge 8 is detached. Fuel transfer may also be accomplished using multiple foams, felts or fabrics of different capillarity and surface properties.

The control system 5 may enables control of various parameters of the different components within the fuel delivery system of the subject matter described herein. The control system 5 may be electrically coupled to the major components within the fuel delivery system in order to receive signals indicative of component operation parameters. The control subsystem 5 may then send actuation signals to modify/adjust performance of each component. The control subsystem 5 may also be coupled to a user interface for transmitting information regarding the performance of the components within the fuel delivery system to a user. The control subsystem 5 may be powered by the fuel cell itself, or an external power source such as battery 9, a solar cell, a capacitor, or a combination thereof.

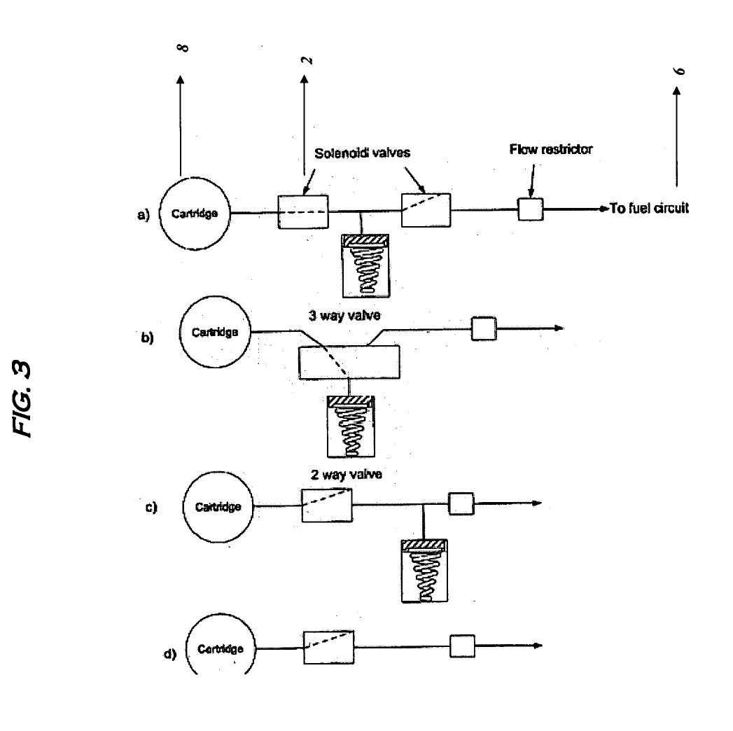

FIG. 4 depicts the various components within a fuel delivery system. In FIG. 4, a container 1, a coupling device 2, a fuel cell stack 6, an air system 7, a water return line 12, a control subsystem 5, are depicted. The container 1 may contain 20 to 500 ml of neat methanol within an extruded aluminum receptacle. The container 1 may have a main cylindrical portion and domed ends. The container 1 may have sufficient structural integrity to withstand highly pressurized contents (e.g., 100 psig) without deforming.

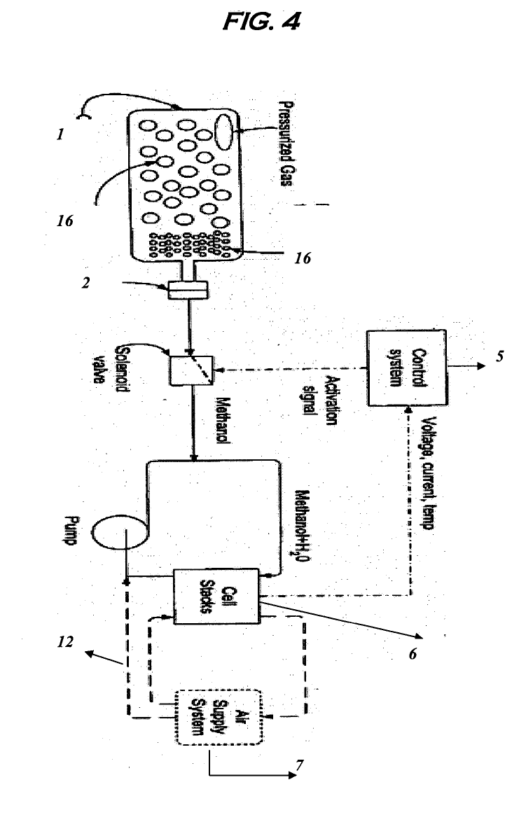

FIG. 5 is an illustration of another variation of the coupling device 2 when coupled with an aerosol container 61. A mechanical latch 62 of dimension “B” engages a part of the container 1 to hold the container 1 firmly against surface C of the coupling device 2. A tube 63 of length A may be provided in order to activate a movable sealing surface 64 of a female aerosol can valve 65 by depressing the surface C by a distance D, which is the minimum distance required to allow a minimum of, for example, 2 cc/min of methanol to exit. A gasket 66 may seal the tube 63 against the valve body 65; thereby confining escape of the methanol to the tube bore 63, and resealing the container 1 when the tube 63 is withdrawn.

FIG. 6 is a depiction of the aerosol can container 61 which may be used to store fuel. The container 61 may comprise a housing 66 with an opening 67 towards one end and a plastic end piece 68 towards an end opposite the opening 67. The opening 67 may comprises a bayonet type lock 69 in order to secure the container 61 to a coupling device 2. The end piece 68 may be secured to the housing 66 by an adhesive material that is compatible with the fuel and water or it may be integral therewith.

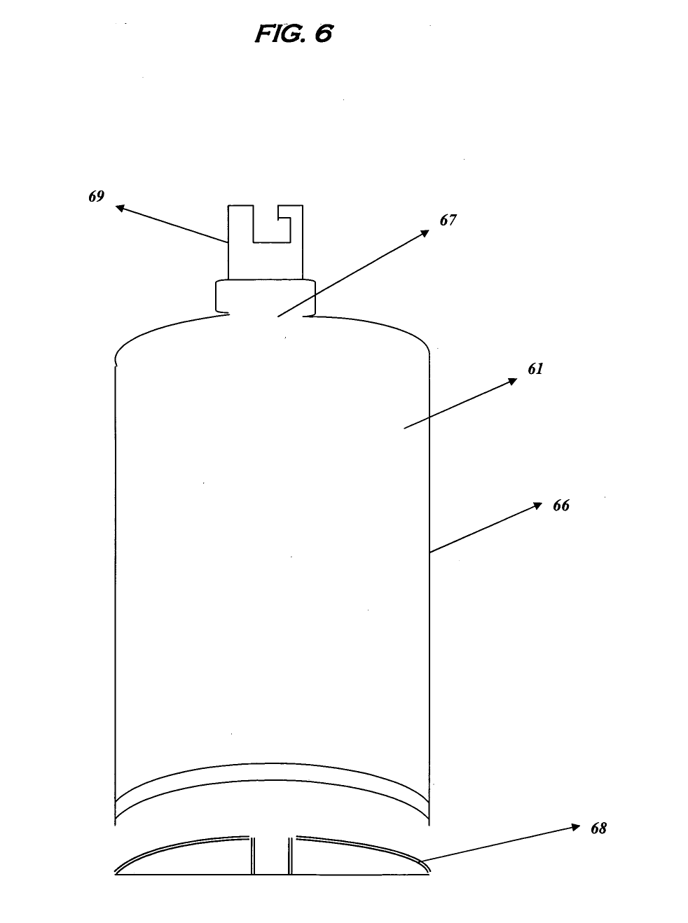

Another variation of a fuel delivery system for use with liquid methanol feed fuel cells is illustrated in FIG. 7. A container 1 of impact-extruded aluminum may be provided which incorporates a bladder 81 to separate a pressurized gas 82 and methanol 83. The pressurized gas 82 may be an environmentally friendly gas such as carbon dioxide to minimize disposal problems. A coupling device 2, as shown in FIG. 5 and as described above may be used to couple with the container 1. The coupling device 2 may be connected in turn to an accumulator 84 including a piston 85 and a spring 86 within a housing 87. The bias of the spring 86 may be selected so as to maintain a relatively constant steady pressure on the exiting methanol stream. A 3-way solenoid valve 81a may be coupled to the accumulator 84 and a control subsystem 5 and be configured to allow methanol 83 to flow from the coupling device 2 into and out of the accumulator 84. In addition, the 3-way solenoid valve may be controlled by the control subsystem 5. A flow restrictor 88 may control the rate of methanol 83 discharged into a fuel feed loop for the cell stack 9. A methanol sensor 83a may be provided in communication with the fuel feed-loop to provide a voltage signal to the control system 5 in response to methanol concentration. The control system 5 may associate the methanol sensor signal with a concentration level, and send an activation signal to the solenoid 81a whenever the methanol concentration falls bellow a predetermined value. This variation provides enhanced control over methanol feed rate and pressure, a fail safe leak resistance system because a solenoid failure in either position prevents leakage out of fuel-cell or excessive pressures of the propellant gas from developing inside fuel-loop, and each piston activation may be counted to provide a more accurate estimate of level of fuel remaining in the container.

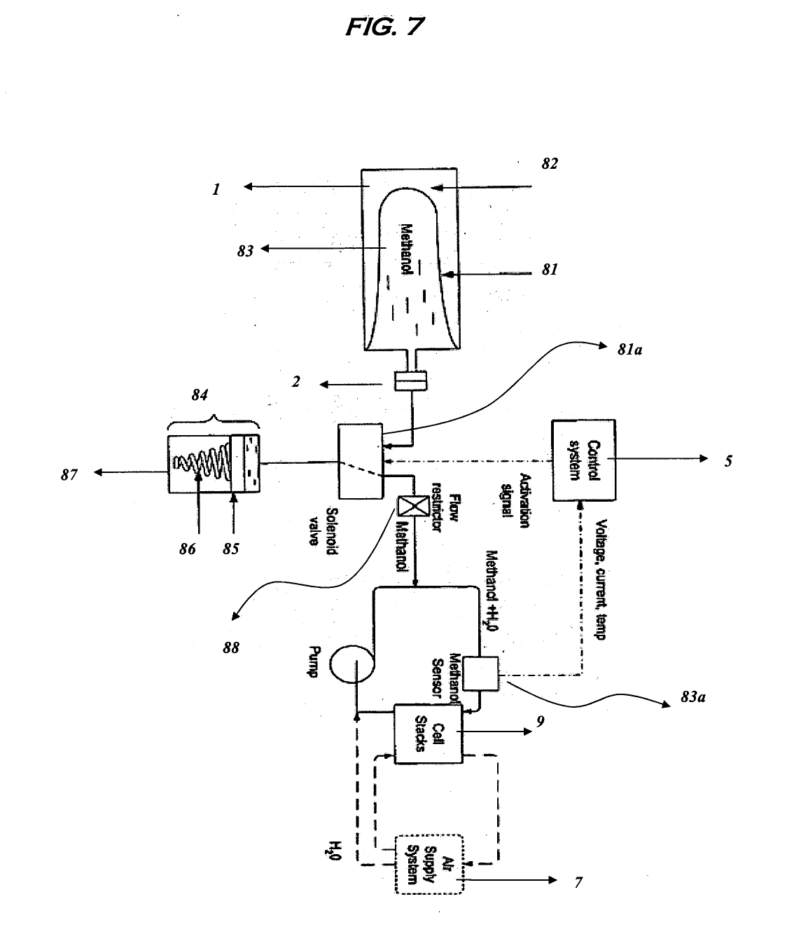

FIG. 8 illustrates another variation of a fuel delivery system, which includes a container 1, coupling device 2, control system 5, and a methanol sensor 91 of the kind used in connection with the variation depicted in FIG. 7. In the variation depicted in FIG. 8, a series of three or more connected pistons P1, P2, P3 that are spring loaded or otherwise biased are provided. A first piston P1 may drive the other two pistons P2, P3 when a liquid is introduced into therein from a pressurized container 1. A second piston P2 may pump the methanol+H2O solution around the fuel feed loop and is double acting as a result of which the piston P2 pumps both when the first piston P1 is filling and when emptying. The third piston P3 may pump the accumulated H2O accumulated in a sump 93 from a water recovery in the air system 94 into the fuel loop. The sump 93 may be configured to collect and store water that is recovered from the exhaust gas condensate of the air supply system 94. A pressure relief valve 95 may direct water back into the sump 93 if pressure in a “H2O replenish” line exceeds a preset value (e.g., when water loss from the fuel loop is less than the attempted water replenishment). In addition, a plurality of check valves V1, V2, V3, V4, V5, V6 may be provided which may be integral with the pistons (such as flapper valves), and which control back flow and cause liquid to circulate as intended. The variation of FIG. 8 provide a fail safe system that prevents back flow of methanol out of the fuel cell if the cartridge is absent, or excessive pressure from occurring in the fuel cell if the solenoid valve should malfunction and remain in one position. Also, the fuel level may be determined by associating the number of piston strokes with methanol remaining in container. Furthermore, this system may use propellant gas pressure to drive the fuel loop circulation pump, thereby eliminating a separate electrically-driven pump. The variation may also employ a third piston P3 to eliminate the need for a water replenishment pump depending on air system design.

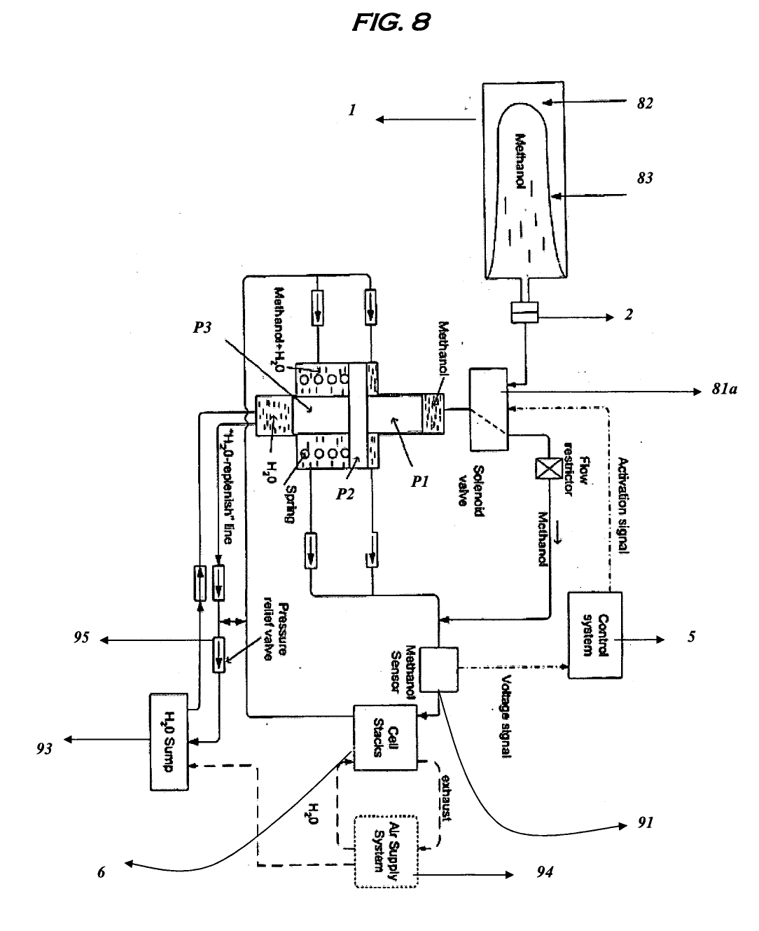

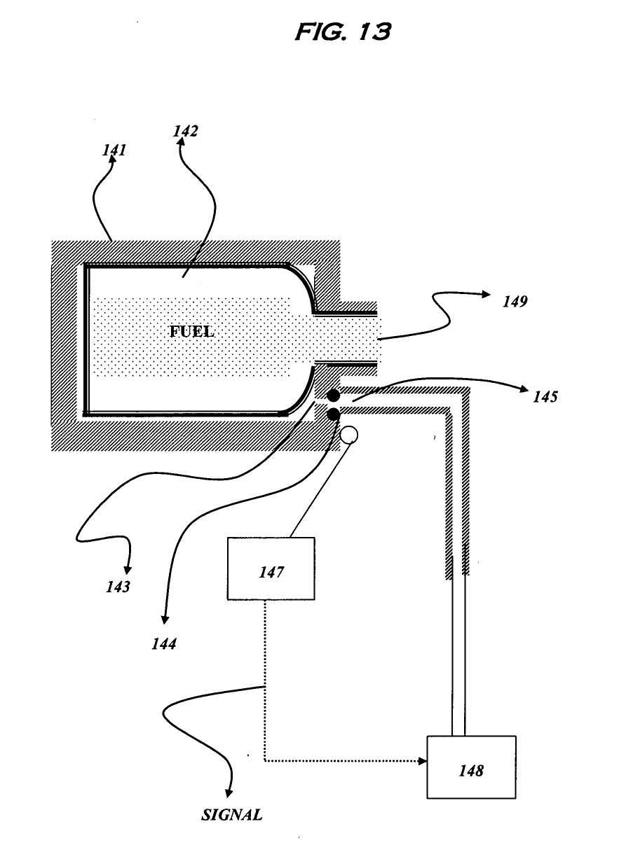

The container 1 may utilize a combination of foam 16 capillary action and gas pressure to eject the methanol. The foams that may be used in the container 1 must possess sufficient capillary force to raise the fuel to an opening if the container 1 is oriented vertically. However, it is known that capillary forces create “holdback”, i.e., fuel which remains trapped and cannot be removed. In the subject matter described herein, this ‘holdback’ is overcome or minimized by the use of progressively higher capillary forces towards the opening. In some variations, the foam is explosion resistant and may act to reduce the collateral damage associated with the ignition of fuel within the container 1. This may be achieved by several different methods, some of which are depicted in FIG. 9 and FIGS. 15A to 15F.

For example, progressively higher capillary forces towards the opening in the cartridge may be achieved by the use of foams of decreasing pore size or by the use of foam and a capillary tube. The foam may comprise a material that has an open cell structure, of 50% to 99% porosity, and that is hydrophilic and compatible with the fuel. Illustrative materials for methanol include polyurethane foams, such as polyether or polyester urethane foams. The polyurethane foams may be felted, reticulated, or felted reticulated foams. If the foam is felted, it may have a compression ratio of approximately 3:1 and it may be manufactured by applying a sufficient amount of heat and pressure to compress foam to a fraction of its original thickness (e.g., ⅓ of the original thickness). A felted foam provides smaller pores (such as in the range of 60 to 80 pores per inch) which increase capillary action. Other materials with similar characteristics may be utilized to provide higher capillary forces including aero gel, porous ceramics, porous silicon, as well as other micro and nano-materials that exhibit capillary action. Such materials may be manufactured using lithography, nano-imprinting, x-ray techniques such as LIGA and from adapting biomaterials.

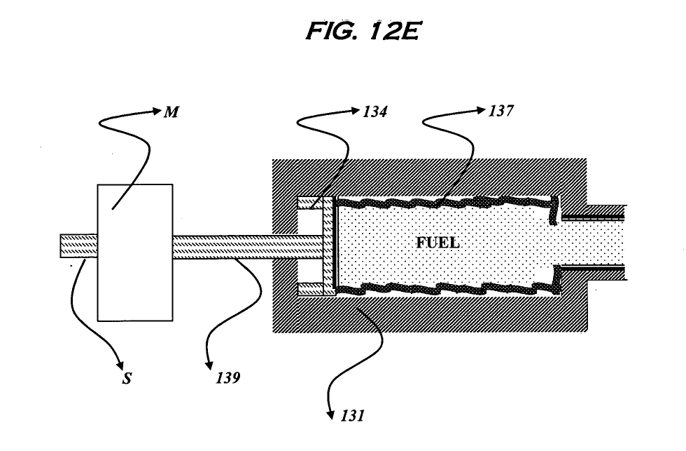

In FIG. 14A, a foam 21 may be used that is compressible and formed in a shape of a wedge. The wedge shape results in progressively more pore compression when inserted into a fixed-dimension case 22, such that pores nearest an opening 23 are smallest (i.e., have greatest capillary force). The variation shown in FIG. 14A includes an expanded view of the foam 21 and cartridge case 22 before insertion of the foam 21 into the case 22, as well as a schematic of the fuel cartridge case 22 after the insertion of the foam 21 therein showing smaller size pores 24 towards the opening 23 and larger size pores towards the end of the case 22 opposite the opening 23.

FIG. 14B is a schematic drawing of another variation wherein progressively increasing pore compression may be achieved towards an opening 23 in a cartridge case 22 by incorporating at least two foam blocks 21a, 21b, 21c, 21d. Each block (e.g., portion) nearer the opening 23 has a smaller pore size than the previous foam block. Thus, in FIG. 14B, foam block 21a has a smaller pore size than foam block 21b. Similarly foam block 21b has a smaller pore size than foam block 21c and so on. Any number of foam blocks 21a, 21b, 21c, 21d may be used, typically from two to a hundred. In some variations, three to four foam blocks 21a, 21b, 21c, 21d, are utilized to achieve progressive pore compression.

In FIG. 14C, progressive pore compression towards the opening 23 may be achieved by arranging foams 21a, 21b, 21c, 21d of different porosities in an annular or concentric manner, the smallest-pore foam being in the center and connected to the opening 23.

An alternative variation is shown in FIG. 14D that comprises a conical-shaped piece of foam 21a that is inserted into a flexible foam 21b with a larger-pore-size, thereby compressing the foam pores in the flexible foam 21b nearest the wedge, thereby reducing their size within the cartridge case 22 (see, for example, FIG. 14E).

FIG. 14F depicts an alternative method of achieving progressive increase in capillary forces towards the opening 23 in the cartridge case 22 by the use of a small-bore capillary tube 25 that is inserted into the foam 21. The bore of the capillary tube 25 may be of a sufficiently small diameter so as to cause capillary force to be able to lift the fuel to the opening 23 if the cartridge 22 is oriented vertically, but may be smaller. The capillary tube 25 may be of any material that is hydrophilic and compatible with the fuel. Glass capillary tubes, for example, may be advantageous in that they are readily available, inexpensive, and inert. An example is a glass capillary tube of 0.1 mm bore.

The fuel on reaching the opening 23, may be transferred to a fuel cell stack 9 by a pump such as a piston, piezoelectric diaphragm and the like or by a continuation of the capillary path. The feed subsystem 3 may comprise a solenoid valve which is electrically activated by the control system 5 and which is configured to allow methanol to flow into the fuel cell feed stream 3 whenever the methanol concentration is very low. The control system 5 coupled to the feed subsystem 3 senses the conditions of voltage, current, and temperature of the fuel cell stack (or selected cell(s) and correlates this to the methanol concentration required to meet the conditions by using an integral algorithm or “look up” table, and subsequently sends an activation signal to the solenoid whenever methanol concentration is too low.

In a illustrative variation depicted in FIG. 9, an open celled foam filler or other wicking material 21 may be used within a cartridge 22 and may comprise smaller pores nearer the opening 23 of the cartridge case 22 in order to impart a greater capillary pull of fuel towards opening 23, together with a high-vapor pressure hydrocarbon inside the cartridge 22 and thereby provide a positive pressure by which to force the fuel from the opening 23 into the fuel cell provided in fuel-delivery system. The graduated porosity may be achieved in the variation of FIG. 9 by forcing a wedge-shaped piece of foam 21 having a substantially uniform pore density 24 into the case 22, thus effectively creating smaller pores near the opening 23 (not shown).

In an alternate variation, a pellet 26 with pores 27 smaller than those of the foam 21 may be inserted in the foam 21 and through the opening 23. The additional hydrocarbon could be butane, which has a vapor pressure of about 45 psia at room temperature, compared to a methanol fuel that has a vapor pressure of 2.7 psia. In addition, the butane is harmless to the operation of methanol fuel cells. Sufficient butane may be added so as to overcome the capillary holding force of the smallest-pore foam/wicking material. Other hydrocarbons suitable for both pressurization and as a fuel source include, for example, dimethyl ether or propane.

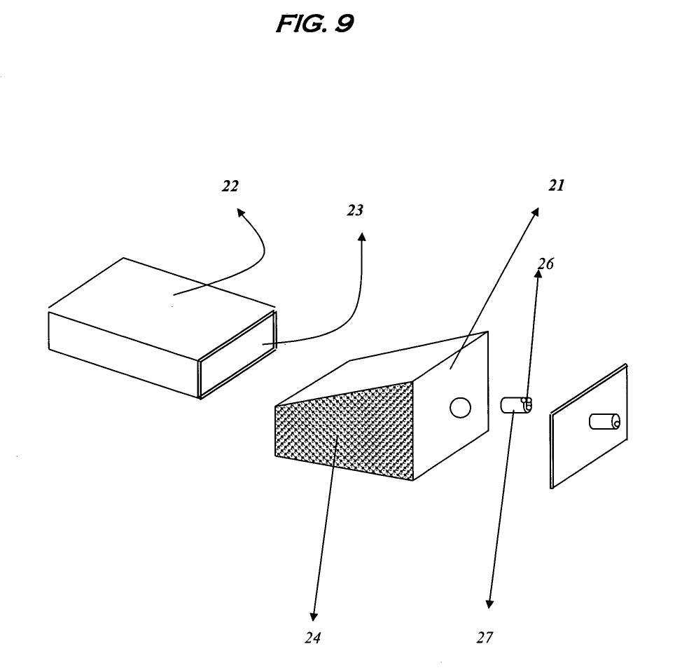

In one variation as depicted in FIG. 10, a cartridge 112 may be coupled to a fuel cell via a cartridge docking slot 111 that may be reinforced in order to withstand any bulging or other external pressures. Removal of the cartridge 112 through an opening 110 may be assisted by providing smooth slick interior walls 113 and a very slight amount of taper. In the variation of FIG. 10, the reinforcement of the cartridge docking slot 111 may be achieved by using one or more ribs 114 provided on the exterior surface 115 thereof. In another variation ribs 116 may also be provided in the cartridge interior 117 perpendicular to the docking-slot ribs 114 in order to enhance resistance to bulging within the docking slot 111. The reinforced cartridge docking station may take other forms to receive cartridges having non-prismatic housings.

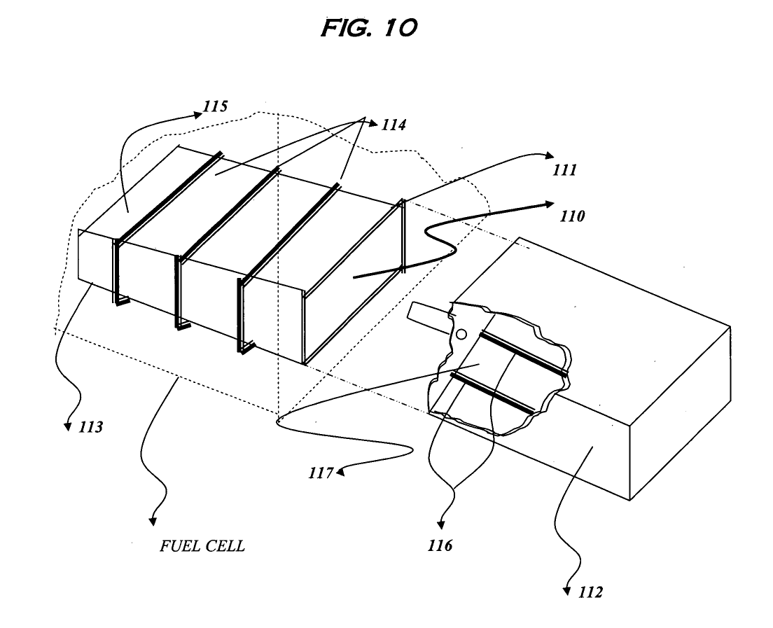

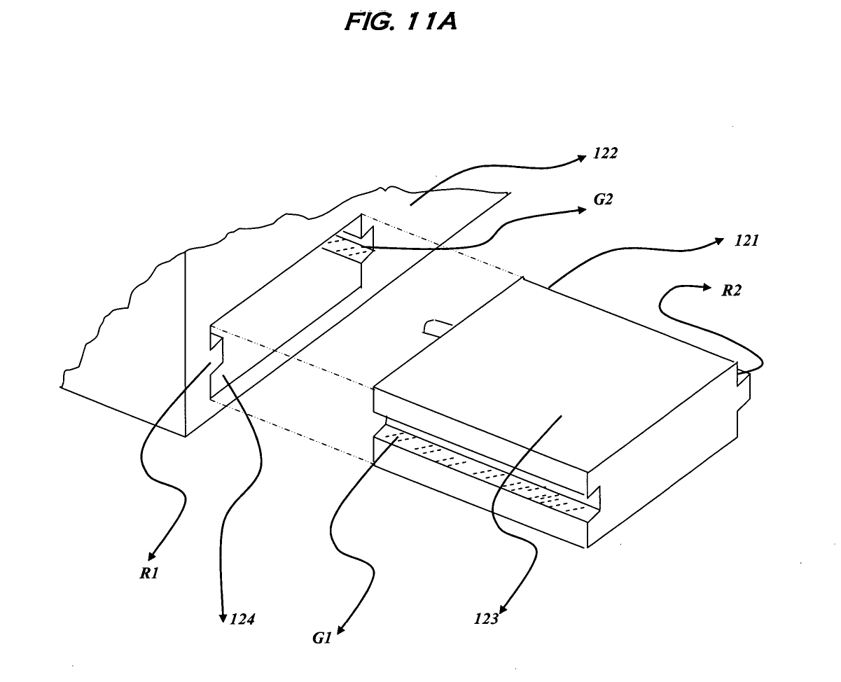

In the variation depicted in FIG. 11A, the cartridge 121 may comprise one or more mechanical members having complimentary corresponding locks in the cartridge docking station 122. In the illustrated variation of FIG. 11A, the cartridge 121 may be equipped with one or more grooves G1, provided on the exterior surface thereof 123 to engage with and fit one or more corresponding ridges R1 provided in the interior surface 124 of the cartridge docking station 122. Similarly, the cartridge docking station 122 may be provided with a groove G2 on the interior surface thereof 124 capable of engaging and fitting into a ridge R2 provided on the exterior surface 123 of the cartridge 121. A combination of both variations may also be possible to avoid the use of counterfeit cartridges. In the variation of FIG. 11B, the mechanical members provided on the cartridge 121 may include notches N, pins P, ridges R, holes H, or other protuberances so as to enable it to fit within, and engage corresponding orifices 125, 125a in the cartridge docking station 122.

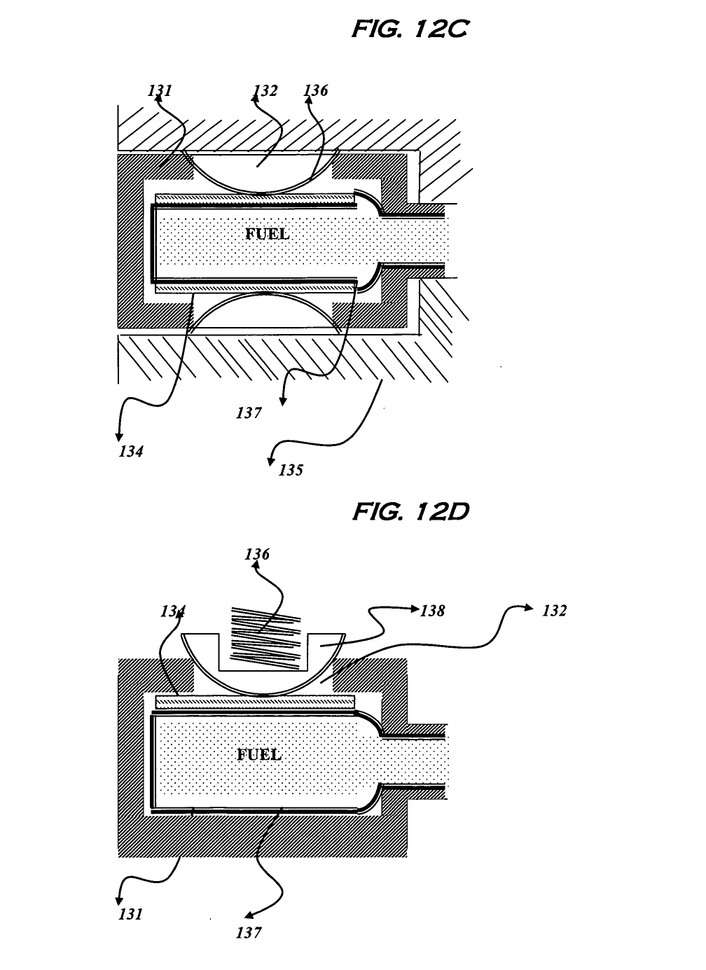

Bellows or bladder may be used within a cartridge case to contain the fuel and a plate or piston against the bladder which is pushed upon by an external spring or activator through an opening in the case such as a slot or a hole. The external spring or activator may remain within and part of the docking station into which the cartridge is inserted, as shown in FIGS. 13A to 13F.

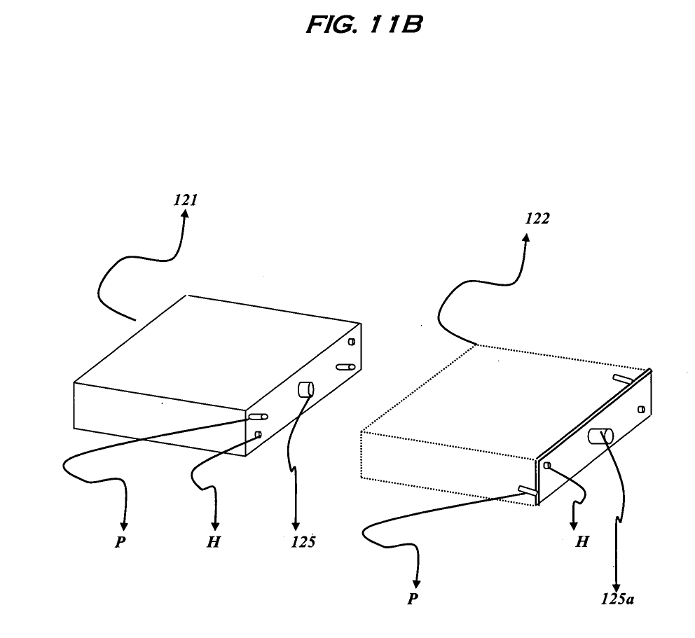

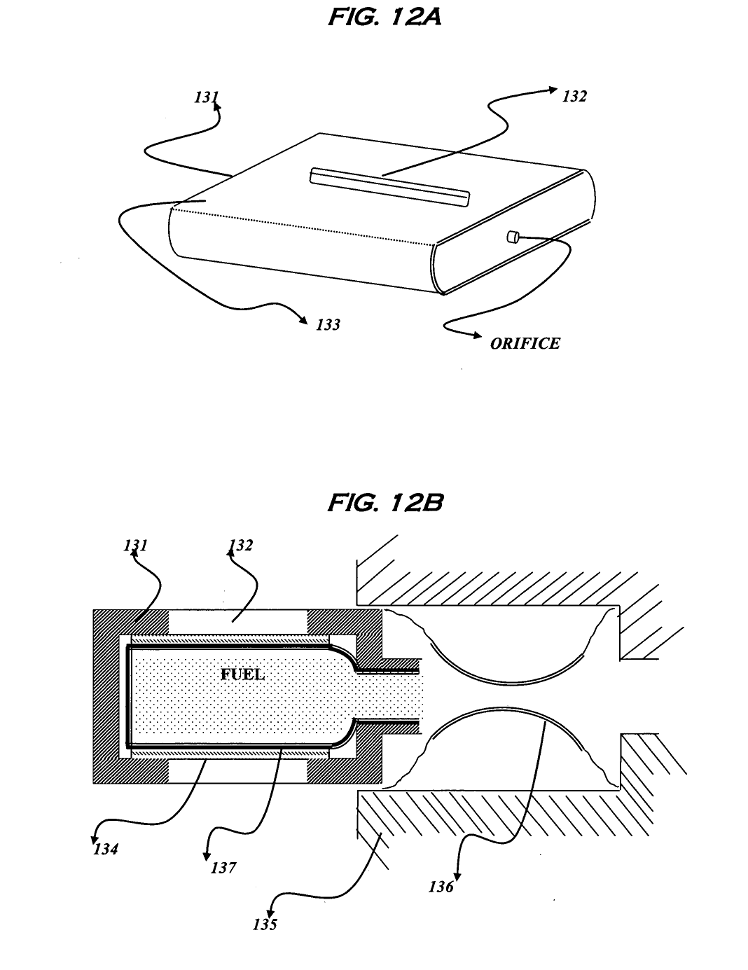

FIG. 12A is a schematic depiction of a variation of a cartridge 131 that may comprise one or more slots 132 on at least the anterior surface 133 thereof. The slots may be configured to receive an external spring/activator (not shown) provided within the interior of a cartridge docking station (also not shown) and depress on a plate/piston provided therein which in turn presses down on bellows or bladder containing the fuel and contained within the cartridge case.

The variations depicted in FIGS. 12B and 13C show methods by which external mechanical cartridge pressurization for prismatic cartridges may be achieved. The cartridge 131 may comprise metal plates 134 on the interior surface thereof which on insertion of the cartridge 131 into a cartridge docking station 135 are pushed down by the action of one or more springs 136 and to pressurize the bellows/bladder 137 provided inside the cartridge case 131. The spring may be a leaf or wire type spring, which is capable of being deflected to admit the cartridge 131 and then squeeze upon the metal plates 134. The plate(s) 134 may be made of hardened metal although other materials such as carbon fiber or plastic or ceramic may also be used. One or more slots 132 may be provided, on one or multiple sides of the cartridge 131 to enable the spring(s) 136 to depress the plate(s) 134.

In FIG. 12D, the spring 136 may depress an external plunger 138. The spring 136 may be leaf or coil type, and the plunger 138 may be provided on any surface of the cartridge case 131. The plunger 138 may in turn depresses the plate(s) 134 thereby providing the external mechanical pressurization on the bellows 137.

In the variation depicted in FIG. 12E, a threaded activating rod 139 may be driven by a rotating motor M and ball screw S, pushing on the plate or piston 134 within the cartridge 131. The plate or piston 134 may be on any surface of the cartridge 131. This action of the activating rod may depress the plate and therefore depresses the bellows 137 thereby resulting in external mechanical pressurization.

With reference to FIG. 13, a fuel-filled bladder 142 may be provided in a case 141 having a central orifice 149. A small external orifice 143 and a seal 144 may be provided on the case 141. The insertion of the cartridge 141 into a fuel cell, and subsequent forcing of pressurized air into the cartridge 141 between the bladder 142 and the case wall 141 results in pressurization of the fuel. The seal 144 may be an O-ring affixed to the cartridge 141 that presses against a sealing surface 145 affixed to the fuel cell. An interlock 147 may signal a pump 148 to provide pressurized air. The pump 148 may be a miniaturized pump and is electrically driven from the fuel cell battery (not shown), and may be of any type. Other pumps may be piston or diaphragm based. Pressurized air may also be provided by other mechanisms, such as air circulation pumps or fans within the fuel cell.

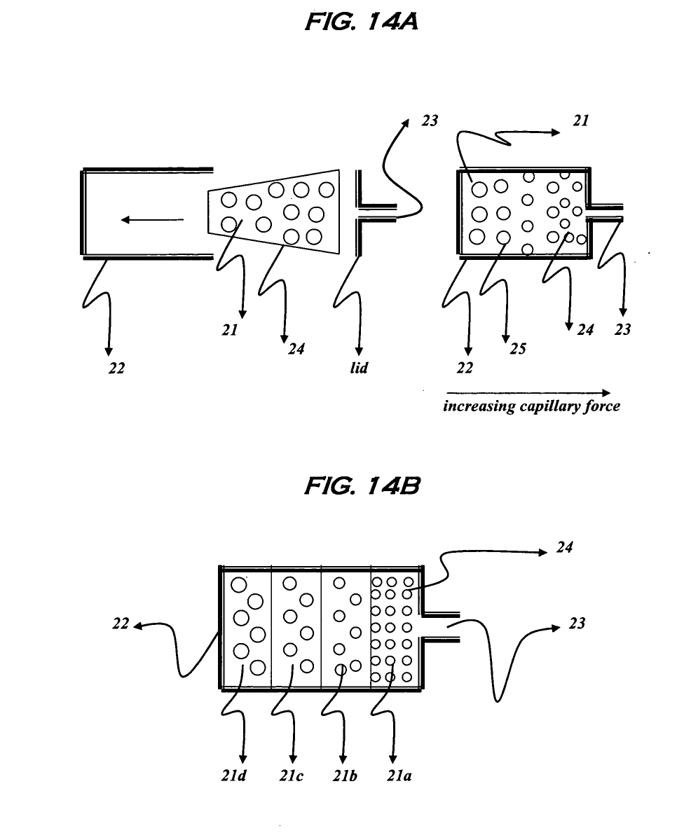

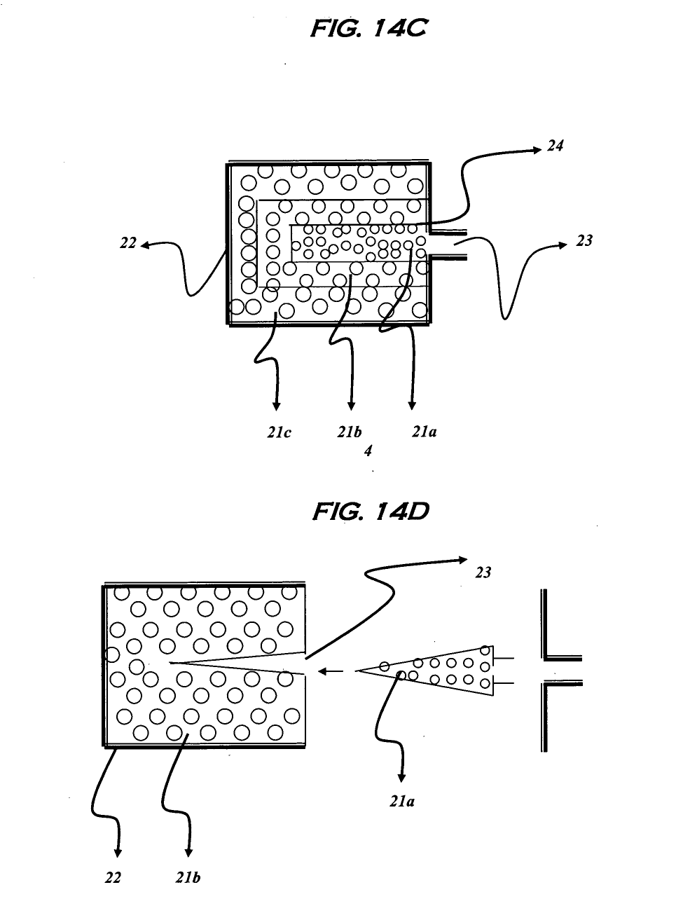

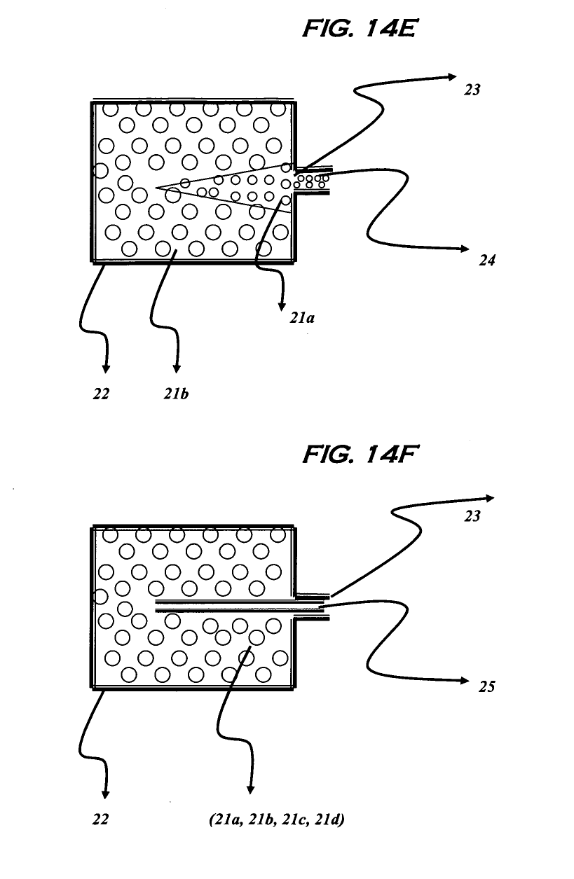

In another variation, an additional hydrocarbon in the fuel may be used to pressurize the cartridge as depicted in FIGS. 15A to 15C. In FIG. 16A, the additional hydrocarbon may be used as a mixture within the methanol fuel. Elements/mechanisms to separate gaseous components from liquid components may be provided in either the cartridge or prior to reaching the fuel cell stack. In the variation illustrated in FIG. 16A, two foams of differing pore sized may be utilized in connection with the added hydrocarbon.

In FIG. 16B, the additional hydrocarbon may be stored external to a bladder 161 containing the fuel (methanol) and may be used to pressurize the bladder 161. In FIG. 16C, the additional hydrocarbon may be used to pressurize a balloon 161 or collapsed bladder 161 provided within the fuel. In this variation the additional hydrocarbon may be provided in the balloon or bladder 161. In one exemplary variation, for a 100 cc cartridge with 85 cc of liquid methanol and 100 psig initial pressure and a minimum of 0.2 psig at the end of fuel delivery (when all methanol is exhausted), a volume of approximately 117 cc of gaseous butane (at 20° C.) may be added to the cartridge. Other high vapor pressure hydrocarbons that are gaseous at normal ambient temperatures such as dimethyl ether or propane may also be used.

In some variations, the pressurized fuel may be used to perform ancillary tasks such as operating a metering pump as depicted in FIG. 16A. The pump 154 may be driven by the fuel pressure and a return spring 156. Each stroke of the piston 155 may provide an estimation of remaining fuel. The pump 154 may be connected on the line coupled to the fuel cartridge 150 and after a solenoid valve 151 which may be electrically coupled to a control line 152.

The dosage pump 154 may be provided with a spring action to regulate the fuel pressure from pressurized cartridges 150. The fuel supply-pressure in the cartridge 150 may vary as the fuel is withdrawn, and a fuel cell stack may require a lower pressure. By using a flow restrictor 153 and a solenoid valve 151 which closes when the dosage pump cavity is filled, the fuel-feed pressure may be maintained in a range controlled by the force of a spring, stretched bladder, or bladder gas-pressure. For example, in a 50 W fuel cell, a piston volume of 0.78 cc provides a stroke approximately once every minute. The spring may maintain the fuel-feed pressure after solenoid-valve closure. For a 1 cm diameter×1 cm long piston cavity, a spring of about 0.122 to 0.025 pounds force over the stroke may maintain a pressure of about 1.0 to 0.2 psig. The pump may be of the diaphragm type shown in FIG. 16B, which offers greater simplicity of construction. The diaphragm pumps of FIG. 16B for example, utilize a flexible neoprene diaphragm 157 to both confine the fuel and provide the spring pressure. The neoprene diaphragm 157 may be initially stretched over a mandrel 158 to provide a preload force. The diaphragm need not be flexible as depicted in FIG. 16C. In this case the return pressure on the fuel is provided by a pressurized gas 159 on the opposite side of bellows, a bladder, or a diaphragm 160. In all the above described variations, the maximum return pressure in the piston does not exceed the minimum exit pressure of fuel from the cartridge. In order to prevent pressure surges when the solenoid is opened, a flow restrictor may be provided in the line between the piston/diaphragm and the fuel cell stack.

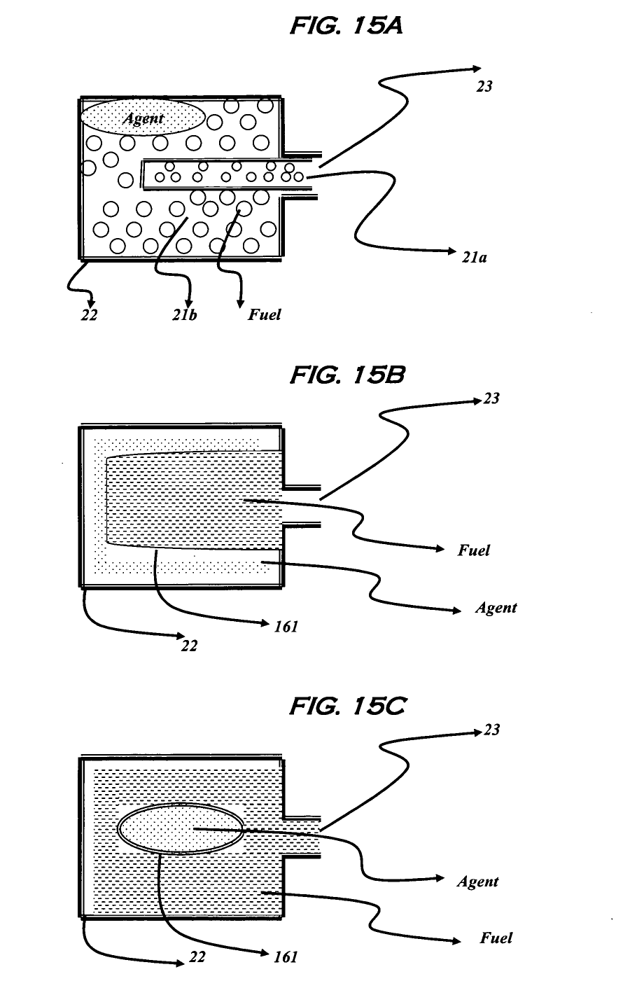

FIG. 17 illustrates a dual tube coupling device 30 having a housing 33, an inlet 31 for receiving fuel from a container 1, a sliding seal 34 (e.g., an O-ring, etc.), a plunging mechanism 37, a series of springs 38 biasing the plunging mechanism 37, a pressurizing fluid/propellant fluid outlet 32. In addition, within the plunging mechanism 37, there is a first fuel outlet 35 and a pressurizing inlet 32. Such an arrangement is analogous to a spool valve. A feature of the coupling is that cartridge side may be spring-loaded in closed position (i.e., fluid-flow openings are sealed and separated from one another and are opened only by insertion of a complimentary member on a docking). When the plunging mechanism 37 is displaced in a direction opposite the fuel outlet 35 and the fluid inlet 32 (and opposite the bias of the springs 38), so that the fuel outlet 35 is in communication with the inlet 31 and the fluid inlet 36 is in communication with the fluid outlet 32. Such a variation may be used with a container 1 that does not have a pressurizing source (e.g., a propellant to displace the fuel). The springs 38 bias the plunging mechanism 37 such that the fuel outlet 35 is not in communication with the inlet 31 and the fluid inlet 36 is not in communication with the fluid outlet 32. In addition, such a variation may also be used in connection with a fuel container utilizing a bladder and/or foam.

The movement of the plunging mechanism 37 may be effected manually or by an automatic driving mechanism (e.g., a solenoid actuator). In the alternative, the plunging mechanism 37 may be stationary within a docking mechanism or coupling device and the insertion of a container 1 causes the plunging mechanism 37 to move opposite the spring 38 bias. With this latter variation, a valve or other mechanism may be incorporated to selectively prevent fluid from flowing in the fluid outlet 35 or the fluid inlet 36.

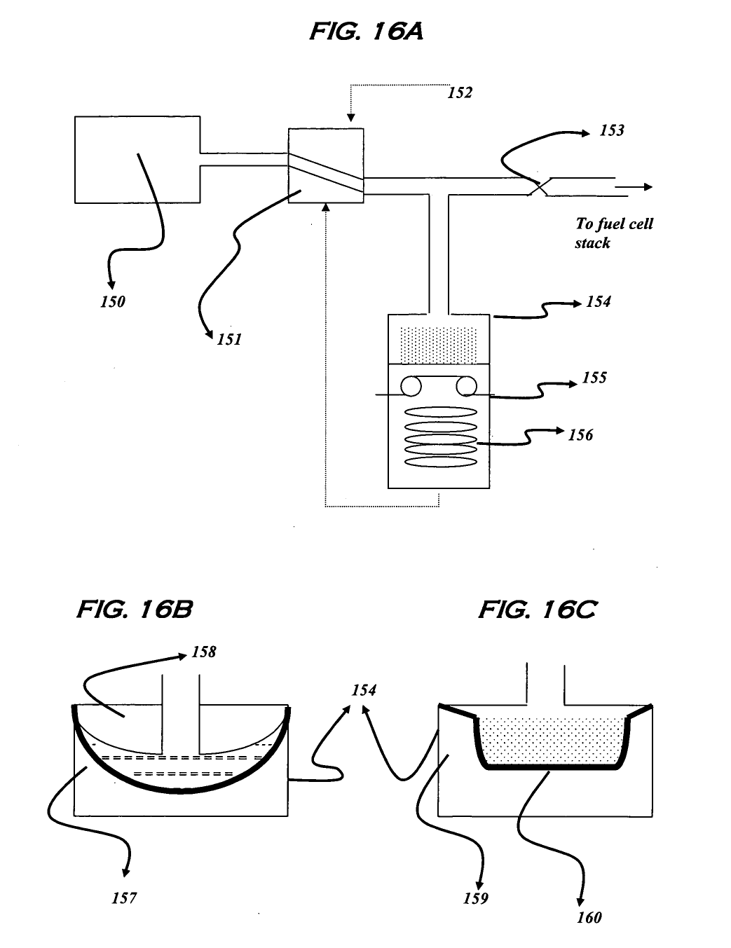

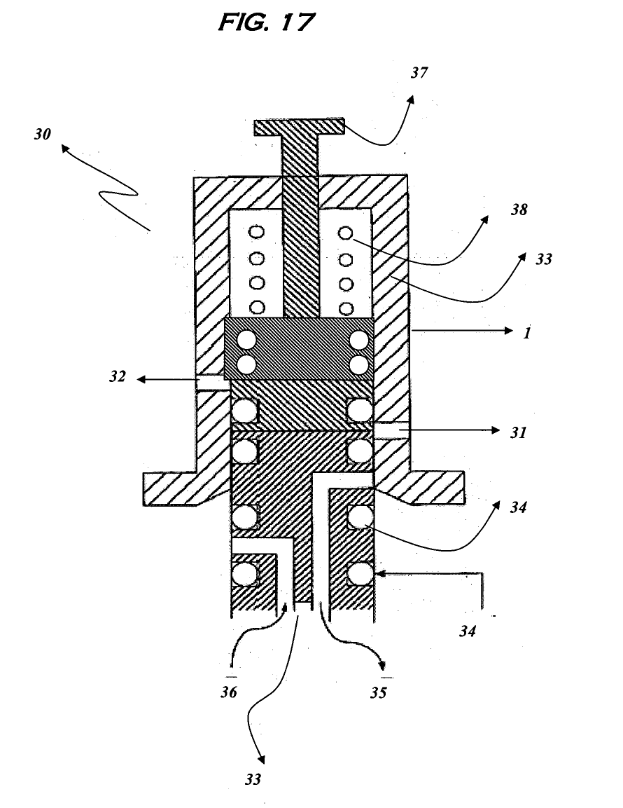

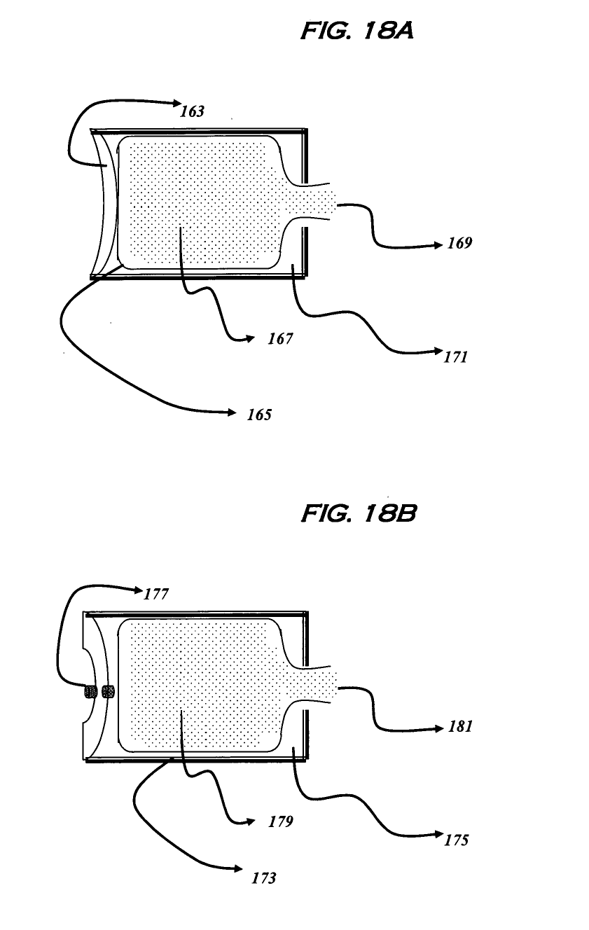

With reference to FIG. 18A, a fuel container 163 may be generally cylindrically shaped with a concave end and an orifice 169 on an opposite end. Within the container, fuel 167 may be surrounded by a bladder 165 or other compressive, flexible, collapsible, and/or elastic material (e.g., neoprene). Disposed between the bladder and an outer wall of the container 163 may be a propellant 171 such as a volatile hydrocarbon (e.g., liquid butane). The bladder 165 should be compatible with both the utilized propellant and the fuel 167. With this variation, the propellant 171 may be first placed within the container 163 via the orifice 169 followed by the bladder 165 and the fuel 167. Thereafter, the orifice 169 may be sealed.

FIG. 18B illustrates a fuel container 173 that may be generally cylindrically shaped and comprise a propellant 175 surrounding a fuel 179. Opposite an orifice 181, the fuel container 173 may comprise an inlet port 177. The port 177 may be, for example, a rubber plug or other mechanism for sealing an opening within a wall of the fuel container 173. With this variation, the fuel 179 may be placed into the fuel container 173 via the opening 181 which is subsequently sealed. The propellant 175 may then later be subsequently introduced into the fuel container 173 via the inlet port 177. Optionally, a bladder may separate the fuel from the propellant.

Referring to FIG. 18C, a fuel container 183 is illustrated that may comprise a piston 185 operable to compress a portion of the container 183 housing a fuel 197. An orifice 199 provides an outlet for the fuel 197 to be delivered to a fuel cell. On an opposite side of the piston 185 from the fuel 197 may be a propellant 189. Sealing the propellant 189 from the fuel 197 may be a seal 187, such as an O-ring. The piston 185 may also include or be coupled to a position sensor 193 which detects the movement of the piston. In one variation, the piston 185 includes magnets 191 which are detected by the position sensor 193 in order to determine position. In addition to magnetic detection of piston location 185, other variations may be implemented that use capacitance, inductance, or acoustic measurement.

A processor 195 coupled to the position sensor 193 may be used to determine an amount of fuel 197 remaining in the fuel container 183 based on the position of the piston 185. The processor 195 may form part of the fuel container 183 or it may be external such that it may be coupled to the fuel container 183 when in use in a fuel cell.

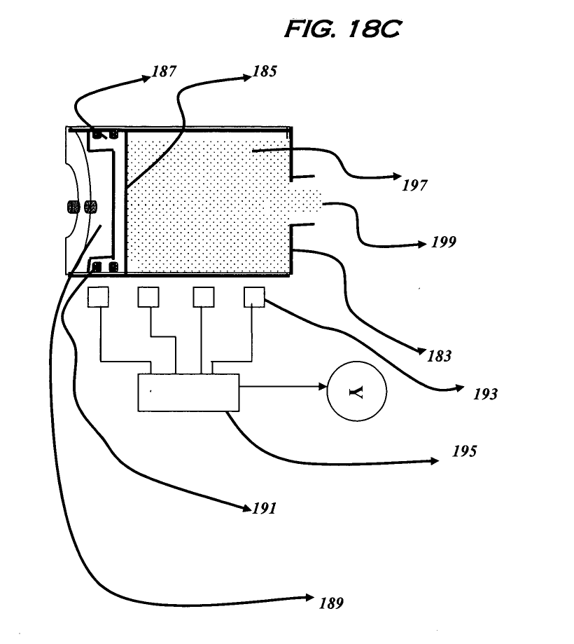

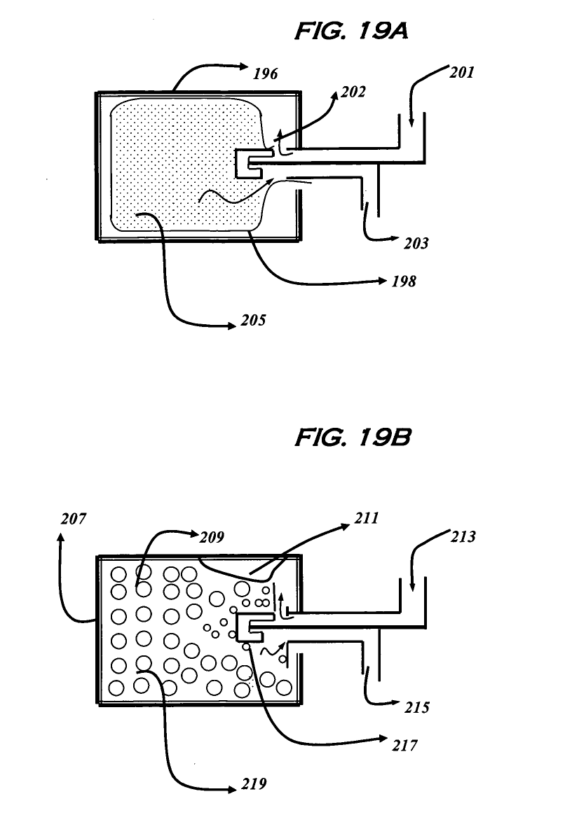

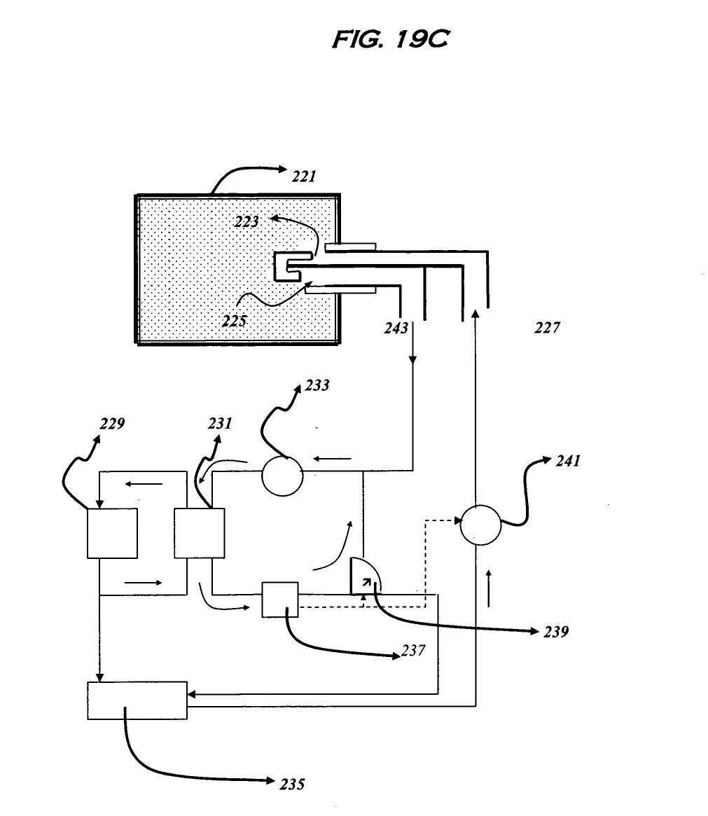

FIGS. 19A-19C illustrates variations in which a container comprises or is coupled to an inlet that is segregated from an outlet. In FIG. 19A, a variation of a container 196 having a bladder 198 surrounding fuel 205 is provided. In addition, the container may be coupled to a pressurizing fluid conduit 201 directing pressurizing fluid into the container 196 and a fuel outlet conduit 203 directing fuel out of the container 196 into a fuel cell and/or a docking station of a fuel cell. Pressurizing fluid is introduced between the bladder 198 and the housing of the container 196 to pressurize the contents of the bladder 198 (and/or to force the fuel out of the bladder 198). The pressurizing fluid conduit 201 and the fuel out conduit 203 may include valves or other mechanisms to selectively restrict fluid flow therein. In some variations, the flow of fluid in the pressurizing fluid conduit 201 may be reversed after some or all of the fuel 205 has been evacuated from the container 205. This would allow the pressurizing fluid to be reused for subsequent containers thereby reducing environmental remediation concerns.

In addition, the container may be coupled to a pressurizing fluid conduit 201 directing pressurizing fluid into the bladder 198 and a fuel outlet conduit 203 directing fuel between the container 196 and bladder walls into a fuel cell and/or a docking station of a fuel cell. Pressurizing fluid is introduced to expand a collapsed bladder 198, squeezing fuel between the container 196 and bladder walls, forcing fuel out through the coupling.

With reference to FIG. 19B, a container 207 having a large pore foam 209 and small pore foam 217 (or a gradient foam) both with fuel 219 disposed therein. A pressurizing gas inlet 213 introduces gas 211 into the container to facilitate the delivery of fuel 219 to a fuel cell or fuel cell docking station via a fuel outlet 215.

FIG. 19C illustrates a container 221 in which water 223 is introduced into the container via a water inlet 227 and a fuel/water mixture 225 exits the container 221 via a fuel outlet 243. The water 223 may be water that is collected from a previous fuel cell operation. With this variation, the container 221 is an integral portion of a fluid circulation sub-system that does not employ a bladder or other device to separate the fuel and product water.

When the container 221 is first utilized, it contains approximately 100% methanol and so the rate of water pumping may be relatively small. As the fuel is depleted and the methanol concentration becomes more dilute, additional water 223 is circulated into the container 221 via the water inlet 227. As the methanol/fuel concentration in the fuel/water mixture 225 approaches the minimum concentration required by a fuel cell, the circulation of water through the container 221 is approximately continuous.

The fuel outlet 243 may be coupled to a pump 233 which facilitates the transfer of the fuel/water mixture 225 to a fuel cell stack 231. The fuel cell stack 231 may be coupled to an air supply system 229 to facilitate the introduction of air into the fuel cell stack 231 and to a methanol concentration sensor 237 for detecting a level of concentration. Depending on the determined level of concentration by the methanol concentration sensor 237, excess water may be removed by a sump 235, the fuel/water mixture 225 may be routed via a valve 239 back to the fuel cell stack 231 via pump 233 or the fuel/water mixture 225 may be directed back into the container 221 via a pump 241 coupled to the water inlet 227. Such a variation is advantageous in that it provides a high volumetric storage efficiency (i.e., the container 221 is filled with fuel), it does not require pressurization, it may operate without regard to container 221 orientation and geometry, and it provides a repository from at least some of the wastewater generated by the fuel cell stack 231.

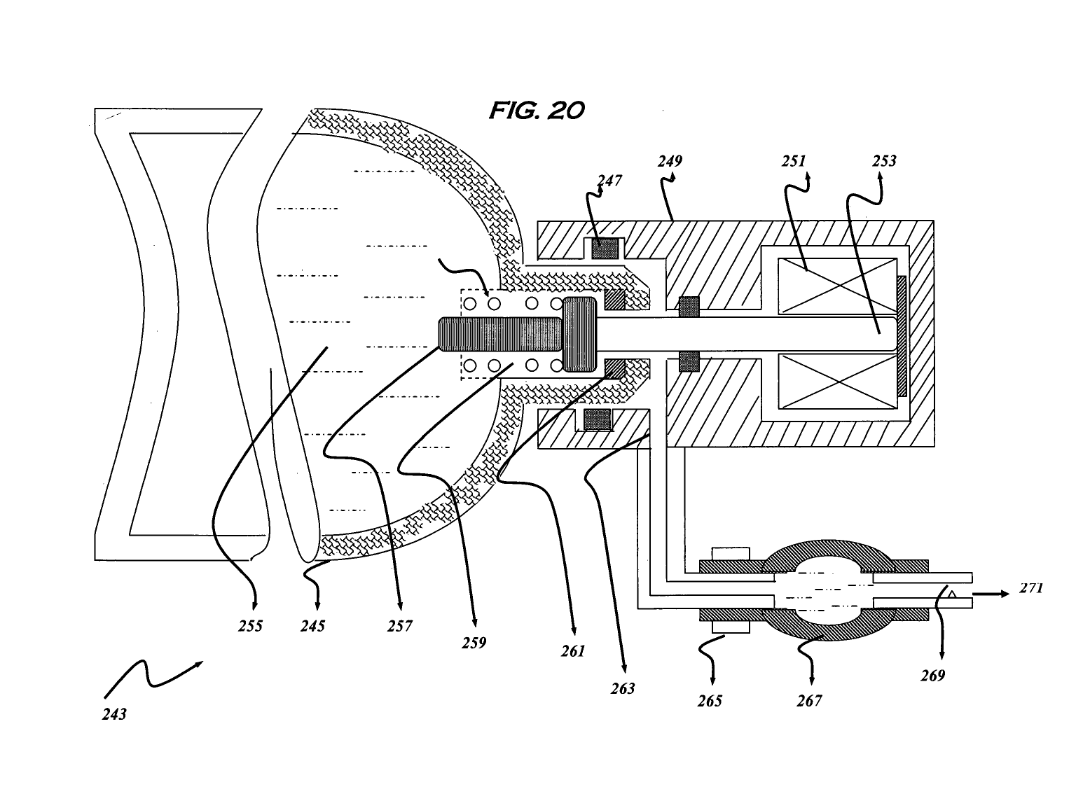

When using pressurized cartridges, the flow and pressure of fuel prior may be regulated prior to its reaching a fuel cell stack. The pressurized fuel cartridge may have a valve, which may be used as an “on demand valve”, in lieu of a separate valve within a fuel cell/docking station. FIG. 20 illustrates a container 245 that may contain pressurized fuel 255. The container 245 includes a valve 257 that may be an integral valve (e.g., an aerosol cylinder with biased springs 259 and a container valve seal 261) and a seal (e.g., O-ring) to ensure a seal between the container 245 and a coupling device 249. The coupling device may also include one or more seals 247 that may cooperate with an outer portion of the container 245. The coupling device 249 may comprise a plunger 253 driven by a solenoid 251 (or other actuation mechanism). When the solenoid 251 is activated, the plunger 253 may move opposite to the bias of springs 259 thereby creating an opening through which pressurized fuel escapes from the container 245 and is directed into a fuel outlet 263 within the coupling device 249. The fuel outlet 263 may be coupled to a pressure regulator 267 which may be connected to the fuel outlet 263 by a securing mechanism 265 (e.g., clamps). A flow restrictor 269 may be coupled to the pressure regulator 267 to limit fuel flow to a fuel cell stack 271. The pressure regulator may comprise, for example, a rubber (or other elastic material) tubular portion that regulates pressure. A control device may be in communication with the solenoid 251 to open the valve 257 so that fuel 255 may be provided to the fuel outlet 263. The control device may, for example, be coupled to a concentration sensor which determines the concentration of fuel in a fuel cell. Other actuation mechanisms may be used such as diaphragms or pistons activated by fluid pressure (e.g., an air pump). Additionally, other components may be used in connection with this variation such as check valves or other restrictors to prevent backflow, additional sealing devices to further ensure that the fuel does not escape into the environment, and the like.

The variations described hereinabove with reference to the accompanying drawings do not depict all the components of a complete implementation of the fuel delivery system of the subject matter described herein, nor are all of the varying component layout schema described. Variations in size, materials, shape, form, function and manner of operation, assembly and use, will be evident to a person skilled in the art and various modifications are possible without departing from the scope and spirit of the subject matter described herein.

What is claimed is:

1. A fuel cartridge for use in a fuel delivery system in a fuel cell, the fuel cartridge comprising:
a fuel reservoir locatable within a fuel container to dispense fuel through a coupling device into the fuel cell;
wherein the reservoir comprises a housing with an anterior wall and a posterior wall, an external surface and an internal surface, fuel outlet provided in the anterior wall and connectable to the fuel cell through the coupling device.

2. A fuel cartridge as in claim 1 wherein the fuel cartridge is multi-walled to house fuel in segregated chambers.

3. A fuel cartridge as in claim 1 wherein the reservoir is made of a corrugated material on at least a portion thereof to provide a compressible/expandable bellows to evacuate fuel therefrom.

4. A fuel cartridge as in claim 1 wherein the reservoir comprises a flexible volume defining chamber provided within a rigid housing.

5. A fuel cartridge as in claim 1 wherein the reservoir comprises a removable barrier to cover the fuel outlet.

6. A fuel cartridge as in claim 1 wherein the reservoir comprises a locking portion at the fuel outlet to secure the cartridge to a coupling device.

7. A fuel cartridge as in claim 1 wherein the cartridge is also provided with a coupling sensor to detect coupling therebetween and a coupling device.

8. A fuel cartridge as in claim 1 further comprising a coupling sensor selected from a group comprising: a micro-switch residing on the housing of the cartridge and actuated on mating of the cartridge and coupling device, a magnetic switch actuated on mating of the cartridge and coupling device, a pair of electrical contacts in contact with a metal portion of the fuel cartridge, and a light detection sensor selected in turn from an optical sensor.

9. A fuel cartridge as in claim 1 wherein the cartridge comprises at least one positive pressure inducing element to dispense fuel therefrom selected from a group consisting an internal-pressure-providing element inside the cartridge, a mechanical force inducing element, and a combination thereof.

10. A fuel cartridge as in claim 1 further comprising a positive pressure inducing element to dispense fuel therefrom comprising a high vapor pressure hydrocarbon added to the fuel.

11. A fuel cartridge as in claim 10 wherein the fuel is methanol and the high vapor pressure hydrocarbon is selected from a group comprising: butane, dimethyl ether and propane.

12. A fuel cartridge as in claim 1 further comprising a positive pressure inducing element to dispense fuel therefrom selected from a group comprising: a piston operable using at least one actuation element selected from a group comprising: spring, a screw, a motor, pneumatic pressure and hydraulic pressure; a portion of the reservoir housing, and an elastomer foam.

13. A fuel cartridge as in claim 1 further comprising a foam with a constant porosity within the container to provide a capillary force.

14. A fuel cartridge as in claim 1 further comprising a foam with a porosity gradient within the container to provide a capillary force.

15. A fuel cartridge as in claim 1 further comprising one or more visco-elastic fluids provided within the container to provide a capillary force.

16. A fuel cartridge as in claim 1 further comprising one or more capillary tubes located within the container to provide a capillary force.

17. A fuel cartridge as in claim 1 wherein the fuel is evacuatable by a gas provided within the cartridge, a gas vent element being incorporated on the cartridge.

18. A fuel cartridge as in claim 1 wherein the cartridge comprises one or more gas storage elements to store a propellant segregated from the fuel.

19. A fuel cartridge as in claim 18 wherein the gas storage element is selected from a group comprising: a bladder, bag, expandable vessel, rupturable capsule, piston separating gas and fuel and compartment coupled to a pressure responsive valve.

20. A fuel cartridge as in claim 1 wherein the cartridge comprises a metering element to control the rate of fuel discharge therefrom.

21. A fuel cartridge as in claim 20 wherein the metering element is selected from a group comprising: metering orifice, porous material, porous element located at the fuel outlet, wicking material located at the outlet of the container and a flow restriction valve.

22. A fuel cartridge as in claim 1 wherein the cartridge comprises a release mechanism to relieve pressure within the cartridge on reaching a predetermined level.

23. A fuel cartridge as in claim 22 wherein the release mechanism is a valve that is opened when a pre-determined pressure level is reached comprising a pressure-sensitive rubber plug mounted within an orifice of the cartridge.

24. A fuel cartridge as in claim 22 wherein the release mechanism is assisted by a foam or a gelling agent located within the fuel to slow release of fuel out from the cartridge.

25. A fuel cartridge as in claim 22 wherein the release mechanism is a pressure-sensitive vent or a selectively permeable membrane.

26. A fuel cartridge as in claim 1 wherein the fuel outlet comprises two or more segregated concentric or coaxial tubes to enable circulation of a portion or all of the fuel stream through the cartridge and to enable exit of fuel and entrance of a gas or liquid.

27. A fuel cartridge as in claim 1 wherein the cartridge comprises a securing element to secure the cartridge against a docking station sealing surface.

28. A fuel cartridge as in claim 27 wherein the securing element is selected from a group comprising: bayonet type lock for a cylindrical cartridge and a molded plastic end cap adhesively attachable for an aerosol can type cartridge.

29. A fuel cartridge as in claim 28 wherein the molded plastic end cap comprises an element to enable grasp and turn to selectively engage or disengage from the docking station sealing surfaces.

30. A fuel cartridge as in claim 28 wherein the bayonet lock comprises a safety element and has a high torque requirement for disengagement.

31. A fuel cartridge as in claim 28 wherein the bayonet lock is a pin and notch type arrangement wherein either the pin or the notch are located on the cartridge external surface and engage with a corresponding notch or pin on the fuel docking station sealing surface.

32. A fuel cartridge for use in a fuel delivery system in a fuel cell, the fuel cartridge comprising:
a fuel reservoir locatable within a fuel container to dispense fuel through a coupling device into a fuel feed loop of a fuel cell;
wherein the reservoir comprises a housing with an anterior wall and a posterior wall, an external surface and an internal surface, fuel outlet provided in the anterior wall and connectable to the fuel cell through the coupling device,
and wherein fuel evacuation is enabled by a capillary action element comprising a foam.

33. A fuel cartridge as in claim 32 wherein the capillary action element further comprises at least one of aero gel, porous ceramics, and porous silicon.

34. A fuel cartridge as in claim 32 wherein the foam has an open cell structure of 50% to 99% porosity, and is of a material that is hydrophilic and compatible with the fuel.

35. A fuel cartridge as in claim 32 wherein the foam is a polyurethane foam with a porosity of 60 to 80 pores per inch.

36. A fuel cartridge as in claim 32 wherein the foam is wedge shaped and is compelled into the cartridge in order to achieve graduated porosity with smaller pores near the fuel outlet.

37. A fuel cartridge as in claim 32 wherein pellets with pores smaller than the pores of the foam are inserted into the pores through the fuel outlet.

38. A fuel cartridge as in claim 32 wherein the foam is used in combination with the high vapor pressure hydrocarbon in order to achieve progressively high capillary forces towards the fuel outlet.

39. A fuel cartridge as in claim 32 wherein the foam material comprises a plurality of foam blocks of differing porosities.

40. A fuel cartridge as in claim 39 wherein each foam block nearer the fuel outlet has a smaller pore size than the previous foam block.

41. A fuel cartridge as in claim 39 wherein the foam blocks comprise foams of different porosities provided in an annular or concentric manner, the smallest-pore foam being in the center and connected to the fuel outlet.

42. A fuel cartridge as in claim 39 wherein the foam blocks comprise a conical-shaped piece of foam inserted into a flexible foam with a larger-pore-size, thereby compressing the foam pores in the flexible foam nearest the outlet.

43. A fuel cartridge for use in a fuel delivery system in a fuel cell, the fuel cartridge comprising:
a fuel reservoir locatable within a fuel container to dispense fuel through a coupling device into a fuel cell;
wherein the reservoir comprises a housing with an anterior wall and a posterior wall, an external surface and an internal surface, fuel outlet provided in the anterior wall and connectable to the fuel feed loop through the coupling device,
the housing comprising an opening towards one end and an end piece towards an end opposite the opening, the opening being provided with an interlocking element to secure the cartridge to a coupling device, the end piece being securable to the housing with a fuel compatible adhesive material or being integral therewith.

44. A fuel cartridge for use in a fuel delivery system in a fuel cell, the fuel cartridge comprising:
a fuel reservoir locatable within a fuel container to dispense fuel through a coupling device into a fuel feed loop of a fuel cell;
wherein the reservoir comprises a housing with an anterior wall and a posterior wall, an external surface and an internal surface, fuel outlet provided in the anterior wall and connectable to the fuel feed loop through the coupling device,
the reservoir being provided with discrete containers to house fuel and a propellant therein.

45. A fuel cartridge as in claim 44 wherein the reservoir comprises an aluminum container incorporating a bladder to separate a pressurized gas and the fuel.

46. A fuel cartridge as in claim 44 wherein the reservoir comprises a piston disposed to separate a pressurized gas and the fuel.

47. A fuel cartridge as in claim 44 further comprising a motion detecting element to calculate movement of the piston.

48. A fuel cartridge as in claim 44 wherein the fuel is methanol and the pressurized gas is carbon dioxide.

49. A fuel cartridge for use in a fuel delivery system in a fuel cell, the fuel cartridge comprising:
a fuel reservoir locatable within a fuel container to dispense fuel through a coupling device into a fuel feed loop of a fuel cell;
wherein the reservoir comprises a housing with an anterior wall and a posterior wall, an external surface and an internal surface, fuel outlet provided in the anterior wall and connectable to the fuel feed loop through the coupling device,
the cartridge being actuated through an opening in the wall by one or more pressure inducing elements to evacuate fuel therefrom.

50. A fuel cartridge as in claim 49 wherein the fuel is contained in bellows or a bladder and the cartridge housing being provided with one or more plates or pistons in contact with the bladder or bellows and actuatable by an actuation element in order to depress the bellows or bladder and thereby evacuate fuel through the fuel outlet of the cartridge.

51. A fuel cartridge as in claim 50 wherein the actuation element comprises one or more external springs operatively associated with the one or more plates or pistons through the one or more slots provided on the cartridge housing.

52. A fuel cartridge as in claim 50 wherein the actuation element comprises a combination of a spring and a plunger element, the plunger element being in operational contact with the plate or piston to depress the bellows or bladder and thereby evacuate fuel through the fuel outlet.

53. A fuel cartridge as in claim 50 wherein the actuation element comprises a threaded activating rod drivable by a rotating motor and screw, thereby pushing on one or more plates or pistons within the cartridge and thereby depressing the bellows thereby resulting in external mechanical pressurization.

54. A fuel cartridge as in claim 49 wherein the pressure inducing element comprises a fuel-filled bladder in the cartridge, a small external orifice provided on the cartridge and a seal therefore to press against a sealing surface of a fuel cell to provide pressurized air.

55. A fuel cartridge as in claim 49 wherein the pressure inducing element comprises one or more hydrocarbons located within the fuel to pressurize the cartridge.

56. A fuel cartridge as in claim 55 wherein the hydrocarbon is used as a mixture within the fuel, and further comprising a separation element being provided to separate the fuel and the hydrocarbon within the cartridge.

57. A fuel cartridge as in claim 55 wherein the additional hydrocarbon is stored external to a bladder containing the fuel.

58. A fuel cartridge as in claim 55 wherein the additional hydrocarbon is stored within a balloon located within the bladder containing the fuel and is used to pressurize the bladder.

59. A fuel cartridge for use in a fuel delivery system in a fuel cell, the fuel cartridge comprising:
a fuel reservoir locatable within a fuel container to dispense fuel through a coupling device into the fuel cell;
wherein the reservoir comprises a housing with an anterior wall and a posterior wall, an external surface and an internal surface, a fuel outlet provided in the anterior wall and connectable to the fuel cell through the coupling device, a fluid inlet connectable to a fluid pressurizing element.

60. A fuel cartridge as in claim 59, further comprising a bladder enveloping fuel and wherein a pressurizing fluid is introduced between the bladder and the internal surface of the fuel reservoir through the fluid inlet.

61. A fuel cartridge as in claim 59, wherein the fluid inlet comprises a plug within one of the anterior and posterior walls of the reservoir.

62. A fuel cartridge as in claim 59, further comprising a plug within the posterior wall of the reservoir and a piston disposed between the plug and the fuel outlet.

63. A fuel cartridge as in claim 62, further comprising a position sensor for monitoring movement of the piston.

64. A fuel cartridge as in claim 63, further comprising a processor coupled to the position sensor for estimating an amount of fuel within the processor based on a position of the piston.

65. An apparatus comprising:
a housing forming a fuel reservoir; and
a spring activated valve that releases fuel within the fuel reservoir in a first position and maintains fuel within the fuel reservoir in a second position, wherein the spring activated valve includes a biasing element for maintaining the valve in the second position and a receiving portion for engaging an external member to oppose the biasing element and cause the valve to shift to the first position when the fuel container is coupled to a fuel cell.

66. A fuel cartridge comprising:
a housing configured to couple to a fuel cell;
an orifice in the housing;
an inlet in the orifice for receiving fuel from a fuel source; and
an outlet segregated from the inlet in the orifice for delivering fuel to a fuel cell.
